(19) United States
(12) Patent Application Publication
(10) Pub. No.: US 2026/0082394 A1
(43) Pub. Date: Mar. 19, 2026

(54) INCREMENTAL REDUNDANCY AND PAYLOAD CHANGE FOR FEEDBACK

(71) Applicant: QUALCOMM Incorporated, San Diego, CA (US)

(72) Inventors: Mostafa KHOSHNEVISAN, San Diego, CA (US); Jing SUN, San Diego, CA (US); Wei YANG, San Diego, CA (US); Jing JIANG, San Diego, CA (US)

(21) Appl. No.: 18/890,589

(22) Filed: Sep. 19, 2024

(51) Int. Cl. H04W 72/232; H04W 72/0446

(52) U.S. Cl. CPC H04W 72/232; H04W 72/0446

(57) ABSTRACT

Methods, systems, and devices for wireless communications are described. A wireless communications system may support transmission of feedback information for downlink data information in multiple feedback payloads across multiple uplink channel slots. For a downlink channel carrying first data information, a user equipment (UE) may transmit feedback information for the data information in two or more uplink channel transmission occasions. A first payload transmitted during a first uplink channel occasion and a second payload transmitted during a second uplink channel occasion may have overlapping information, such as feedback information for the first data information, but may not be identical. The first payload may include feedback information for a first set of downlink channel transmissions, and the second payload may include feedback information for the first set of downlink channel transmissions and a second set of downlink channel transmissions.

### INTRODUCTION

The following relates to wireless communications that pertain to feedback reporting redundancy. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method of wireless communication performed by a network entity is described. The method may include receiving first downlink control information (DCI) that schedules a first set of one or more downlink shared channel transmissions, transmitting, during a first uplink channel transmission occasion based on a first slot offset, first feedback information associated with the first set of one or more downlink shared channel transmissions, receiving second DCI that schedules a second set of one or more downlink shared channel transmissions, and transmitting, during a second uplink channel transmission occasion based on a second slot offset, the first feedback information and second feedback information in a single payload, where the second feedback information is associated with the second set of one or more downlink shared channel transmissions.

A network entity for wireless communication is described. The network entity may include one or more memories storing processor executable code, and one or more processors coupled with the one or more memories. The one or more processors may individually or collectively be operable to execute the code to cause the network entity to receive first DCI that schedules a first set of one or more downlink shared channel transmissions, transmit, during a first uplink channel transmission occasion based on a first slot offset, first feedback information associated with the first set of one or more downlink shared channel transmissions, receive second DCI that schedules a second set of one or more downlink shared channel transmissions, and transmit, during a second uplink channel transmission occasion based on a second slot offset, the first feedback information and second feedback information in a single payload, where the second feedback information is associated with the second set of one or more downlink shared channel transmissions.

Another network entity for wireless communication is described. The network entity may include means for receiving first DCI that schedules a first set of one or more downlink shared channel transmissions, means for transmitting, during a first uplink channel transmission occasion based on a first slot offset, first feedback information associated with the first set of one or more downlink shared channel transmissions, means for receiving second DCI that schedules a second set of one or more downlink shared channel transmissions, and means for transmitting, during a second uplink channel transmission occasion based on a second slot offset, the first feedback information and second feedback information in a single payload, where the second feedback information is associated with the second set of one or more downlink shared channel transmissions.

A non-transitory computer-readable medium storing code for wireless communication is described. The code may include instructions executable by one or more processors to receive first DCI that schedules a first set of one or more downlink shared channel transmissions, transmit, during a first uplink channel transmission occasion based on a first slot offset, first feedback information associated with the first set of one or more downlink shared channel transmissions, receive second DCI that schedules a second set of one or more downlink shared channel transmissions, and transmit, during a second uplink channel transmission occasion based on a second slot offset, the first feedback information and second feedback information in a single payload, where the second feedback information is associated with the second set of one or more downlink shared channel transmissions.

In some examples of the method, network entities, and non-transitory computer-readable medium described herein, the first DCI indicates the first slot offset and the second slot offset corresponds to a quantity of one or more slots relative to a next available slot from a reference slot corresponding to the first uplink channel transmission occasion.

In some examples of the method, network entities, and non-transitory computer-readable medium described herein, the next available slot does not overlap with a synchronization signal block or one or more downlink symbols.

Some examples of the method, network entities, and non-transitory computer-readable medium described herein may further include operations, features, means, or instructions for receiving signaling that indicates a quantity of one or more uplink channel transmission occasions to use to transmit feedback, where the quantity includes at least the first uplink channel transmission occasion and the second uplink channel transmission occasion.

In some examples of the method, network entities, and non-transitory computer-readable medium described herein, the signaling indicates a respective quantity of one or more uplink channel transmission occasions to use to transmit feedback for each downlink component carrier of a set of one or more downlink component carriers.

In some examples of the method, network entities, and non-transitory computer-readable medium described herein, the signaling indicates a respective quantity of one or more uplink channel transmission occasions to use to transmit feedback for each uplink component carrier of a set of one or more uplink component carriers.

In some examples of the method, network entities, and non-transitory computer-readable medium described herein, the signaling indicates a respective quantity of one or more uplink channel transmission occasions to use to transmit feedback for each uplink control channel format of a set of one or more uplink control channel formats.

In some examples of the method, network entities, and non-transitory computer-readable medium described herein, the signaling indicates a respective quantity of one or more uplink channel transmission occasions to use to transmit feedback for each uplink control channel resource of a set of one or more uplink control channel resources.

In some examples of the method, network entities, and non-transitory computer-readable medium described herein, the signaling includes radio resource control signaling, medium access control-control element signaling, DCI signaling, or a combination thereof.

In some examples of the method, network entities, and non-transitory computer-readable medium described herein, the first DCI indicates a quantity of one or more uplink channel transmission occasions to use to transmit feedback and the quantity includes at least the first uplink channel transmission occasion and the second uplink channel transmission occasion.

In some examples of the method, network entities, and non-transitory computer-readable medium described herein, the first DCI indicates the first slot offset and the second slot offset.

In some examples of the method, network entities, and non-transitory computer-readable medium described herein, the first slot offset and the second slot offset may be a same slot offset.

In some examples of the method, network entities, and non-transitory computer-readable medium described herein, the first DCI indicates a first identifier associated with a set of slot offsets and the set of slot offsets includes the first slot offset and the second slot offset.

In some examples of the method, network entities, and non-transitory computer-readable medium described herein, the first slot offset corresponds to a first quantity of one or more slots between a first downlink shared channel transmission of the first set of one or more downlink shared channel transmissions and the first uplink channel transmission occasion and the second slot offset corresponds to a second quantity of one or more slots between the first downlink shared channel transmission and the second uplink channel transmission occasion.

In some examples of the method, network entities, and non-transitory computer-readable medium described herein, the first slot offset corresponds to a first quantity of one or more slots between a first downlink shared channel transmission of the first set of one or more downlink shared channel transmissions and the first uplink channel transmission occasion and the second slot offset corresponds to a second quantity of one or more slots between the first uplink channel transmission occasion and the second uplink channel transmission occasion.

In some examples of the method, network entities, and non-transitory computer-readable medium described herein, transmitting the first feedback information and the second feedback information may include operations, features, means, or instructions for multiplexing the second feedback information and the first feedback information on a channel that overlaps with the second uplink channel transmission occasion.

In some examples of the method, network entities, and non-transitory computer-readable medium described herein, transmitting the first feedback information and the second feedback information may include operations, features, means, or instructions for multiplexing the second feedback information and the first feedback information with uplink control information, where the second uplink channel transmission occasion overlaps with an uplink control channel for the uplink control information, and where the uplink control information may be transmitted with the second feedback information and the first feedback information.

In some examples of the method, network entities, and non-transitory computer-readable medium described herein, the second uplink channel transmission occasion includes a feedback slot for a set of downlink shared channels that includes at least a first downlink shared channel transmission of the first set of one or more downlink shared channel transmissions and a second downlink shared channel transmission of the second set of one or more downlink shared channel transmissions based on a difference between a slot index of the feedback slot and the second slot offset.

Some examples of the method, network entities, and non-transitory computer-readable medium described herein may further include operations, features, means, or instructions for transmitting capability information associated with a threshold quantity of uplink channel transmission occasions that the network entity supports for feedback transmissions.

Some examples of the method, network entities, and non-transitory computer-readable medium described herein may further include operations, features, means, or instructions for transmitting capability information that indicates a threshold quantity of slots that the network entity supports for buffering feedback information, where the threshold quantity of slots corresponds to a quantity of slots after a downlink shared channel.

Some examples of the method, network entities, and non-transitory computer-readable medium described herein may further include operations, features, means, or instructions for transmitting capability information that indicates a threshold quantity of slots that the network entity supports for buffering feedback information, where the threshold quantity of slots corresponds to a quantity of slots after an initial transmission of the feedback information.

A method of wireless communication performed by a network entity is described. The method may include outputting first DCI that schedules a first set of one or more downlink shared channel transmissions, obtaining, during a first uplink channel transmission occasion based on a first slot offset, first feedback information associated with the first set of one or more downlink shared channel transmissions, outputting second DCI that schedules a second set of one or more downlink shared channel transmissions, and obtaining, during a second uplink channel transmission occasion based on a second slot offset, the first feedback information and second feedback information in a single payload, where the second feedback information is associated with the second set of one or more downlink shared channel transmissions.

A network entity for wireless communication is described. The network entity may include one or more memories storing processor executable code, and one or more processors coupled with the one or more memories. The one or more processors may individually or collectively be operable to execute the code to cause the network entity to output first DCI that schedules a first set of one or more downlink shared channel transmissions, obtain, during a first uplink channel transmission occasion based on a first slot offset, first feedback information associated with the first set of one or more downlink shared channel transmissions, output second DCI that schedules a second set of one or more downlink shared channel transmissions, and obtain, during a second uplink channel transmission occasion based on a second slot offset, the first feedback information and second feedback information in a single payload, where the second feedback information is associated with the second set of one or more downlink shared channel transmissions.

Another network entity for wireless communication is described. The network entity may include means for outputting first DCI that schedules a first set of one or more downlink shared channel transmissions, means for obtaining, during a first uplink channel transmission occasion based on a first slot offset, first feedback information associated with the first set of one or more downlink shared channel transmissions, means for outputting second DCI that schedules a second set of one or more downlink shared channel transmissions, and means for obtaining, during a second uplink channel transmission occasion based on a second slot offset, the first feedback information and second feedback information in a single payload, where the second feedback information is associated with the second set of one or more downlink shared channel transmissions.

A non-transitory computer-readable medium storing code for wireless communication is described. The code may include instructions executable by one or more processors to output first DCI that schedules a first set of one or more downlink shared channel transmissions, obtain, during a first uplink channel transmission occasion based on a first slot offset, first feedback information associated with the first set of one or more downlink shared channel transmissions, output second DCI that schedules a second set of one or more downlink shared channel transmissions, and obtain, during a second uplink channel transmission occasion based on a second slot offset, the first feedback information and second feedback information in a single payload, where the second feedback information is associated with the second set of one or more downlink shared channel transmissions.

In some examples of the method, network entities, and non-transitory computer-readable medium described herein, the first DCI indicates the first slot offset and the second slot offset corresponds to a quantity of one or more slots relative to a next available slot from a reference slot corresponding to the first uplink channel transmission occasion.

Some examples of the method, network entities, and non-transitory computer-readable medium described herein may further include operations, features, means, or instructions for outputting signaling that indicates a quantity of one or more uplink channel transmission occasions to use to transmit feedback, where the quantity includes at least the first uplink channel transmission occasion and the second uplink channel transmission occasion.

In some examples of the method, network entities, and non-transitory computer-readable medium described herein, the first DCI indicates a quantity of one or more uplink channel transmission occasions to use to transmit feedback and the quantity includes at least the first uplink channel transmission occasion and the second uplink channel transmission occasion.

In some examples of the method, network entities, and non-transitory computer-readable medium described herein, the first DCI indicates the first slot offset and the second slot offset.

In some examples of the method, network entities, and non-transitory computer-readable medium described herein, the first DCI indicates a first identifier associated with a set of slot offsets and the set of slot offsets includes the first slot offset and the second slot offset.

In some examples of the method, network entities, and non-transitory computer-readable medium described herein, the first slot offset corresponds to a first quantity of one or more slots between a first downlink shared channel transmission of the first set of one or more downlink shared channel transmissions and the first uplink channel transmission occasion and the second slot offset corresponds to a second quantity of one or more slots between the first downlink shared channel transmission and the second uplink channel transmission occasion.

In some examples of the method, network entities, and non-transitory computer-readable medium described herein, the first slot offset corresponds to a first quantity of one or more slots between a first downlink shared channel transmission of the first set of one or more downlink shared channel transmissions and the first uplink channel transmission occasion and the second slot offset corresponds to a second quantity of one or more slots between the first uplink channel transmission occasion and the second uplink channel transmission occasion.

In some examples of the method, network entities, and non-transitory computer-readable medium described herein, the second uplink channel transmission occasion includes a feedback slot for a set of downlink shared channels that includes at least a first downlink shared channel transmission of the first set of one or more downlink shared channel transmissions and a second downlink shared channel of the second set of one or more downlink shared channel transmissions based on a difference between a slot index of the feedback slot and the second slot offset.

Some examples of the method, network entities, and non-transitory computer-readable medium described herein may further include operations, features, means, or instructions for obtaining capability information associated with a threshold quantity of uplink channel transmission occasions that a second network entity supports for feedback transmissions.

Some examples of the method, network entities, and non-transitory computer-readable medium described herein may further include operations, features, means, or instructions for obtaining capability information that indicates a threshold quantity of slots that a second network entity supports for buffering feedback information, where the threshold quantity of slots corresponds to a first quantity of slots after a downlink shared channel, or a second quantity of slots after an initial transmission of the feedback information.

In some examples of the method, network entities, and non-transitory computer-readable medium described herein, jointly decoding the first feedback information obtained via the first uplink channel transmission occasion and the first feedback information obtained via the second uplink channel transmission occasion.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports incremental redundancy and payload change for feedback in accordance with one or more aspects of the present disclosure.

FIG. 2 shows an example of a wireless communications system that supports incremental redundancy and payload change for feedback in accordance with one or more aspects of the present disclosure.

FIG. 3 shows an example of a slot offset indication scheme that supports incremental redundancy and payload change for feedback in accordance with one or more aspects of the present disclosure.

FIG. 4 shows an example of a multiplexing scheme that supports incremental redundancy and payload change for feedback in accordance with one or more aspects of the present disclosure.

FIG. 5 shows an example of a process flow that supports incremental redundancy and payload change for feedback in accordance with one or more aspects of the present disclosure.

FIGS. 6 and 7 show block diagrams of devices that support incremental redundancy and payload change for feedback in accordance with one or more aspects of the present disclosure.

FIG. 8 shows a block diagram of a communications manager that supports incremental redundancy and payload change for feedback in accordance with one or more aspects of the present disclosure.

FIG. 9 shows a diagram of a system including a device that supports incremental redundancy and payload change for feedback in accordance with one or more aspects of the present disclosure.

FIGS. 10 and 11 show block diagrams of devices that support incremental redundancy and payload change for feedback in accordance with one or more aspects of the present disclosure.

FIG. 12 shows a block diagram of a communications manager that supports incremental redundancy and payload change for feedback in accordance with one or more aspects of the present disclosure.

FIG. 13 shows a diagram of a system including a device that supports incremental redundancy and payload change for feedback in accordance with one or more aspects of the present disclosure.

FIGS. 14 through 17 show flowcharts illustrating methods that support incremental redundancy and payload change for feedback in accordance with one or more aspects of the present disclosure.

### DETAILED DESCRIPTION

A network entity may transmit downlink control information (DCI) via a physical downlink control channel (PDCCH) to schedule a physical downlink shared channel (PDSCH) for transmission of downlink data information to a user equipment (UE). The DCI may indicate a slot offset between a PDSCH slot carrying the downlink data information and a physical uplink control channel (PUCCH) slot the UE is to use to transmit hybrid automatic repeat request (HARQ) feedback for the downlink data information. In some wireless communications systems, a UE may be configured to transmit uplink control information, including HARQ feedback, over multiple PUCCH repetitions. However, some systems may not support multiplexing uplink control information on a physical uplink shared channel (PUSCH) or multiplexing uplink control information on a PUCCH. For uplink repetition, these restrictions may ensure the same payload and coded bits are transmitted across different PUCCH repetitions for soft combining at the network. Due to these restrictions, PUCCH repetition in these systems is not flexible.

A wireless communications system described herein supports transmission of feedback information for downlink data information in multiple feedback payloads across multiple PUCCH slots. For example, for a PDSCH carrying first data information, a UE may transmit HARQ feedback for the data information in two or more PUCCH transmission occasions. A first payload transmitted during a first PUCCH occasion and a second payload transmitted during a second PUCCH occasion may have overlapping information, such as HARQ feedback for the first data information, but may not be identical. For example, the first payload may include HARQ feedback for a first set of PDSCH transmissions, and the second payload may include HARQ feedback for the first set of PDSCH transmissions and a second set of PDSCH transmissions. Additional techniques for identifying PUCCH slots for transmitting the HARQ feedback, multiplexing HARQ feedback with other uplink transmissions, and constructing a feedback codebook are described.

Aspects of the disclosure are initially described in the context of wireless communications systems. Aspects of the disclosure are then described with reference to a slot offset indication scheme, a multiplexing scheme, and a process flow. Aspects of the disclosure are further illustrated by and described with reference to apparatus diagrams, system diagrams, and flowcharts that relate to incremental redundancy and payload change for feedback.

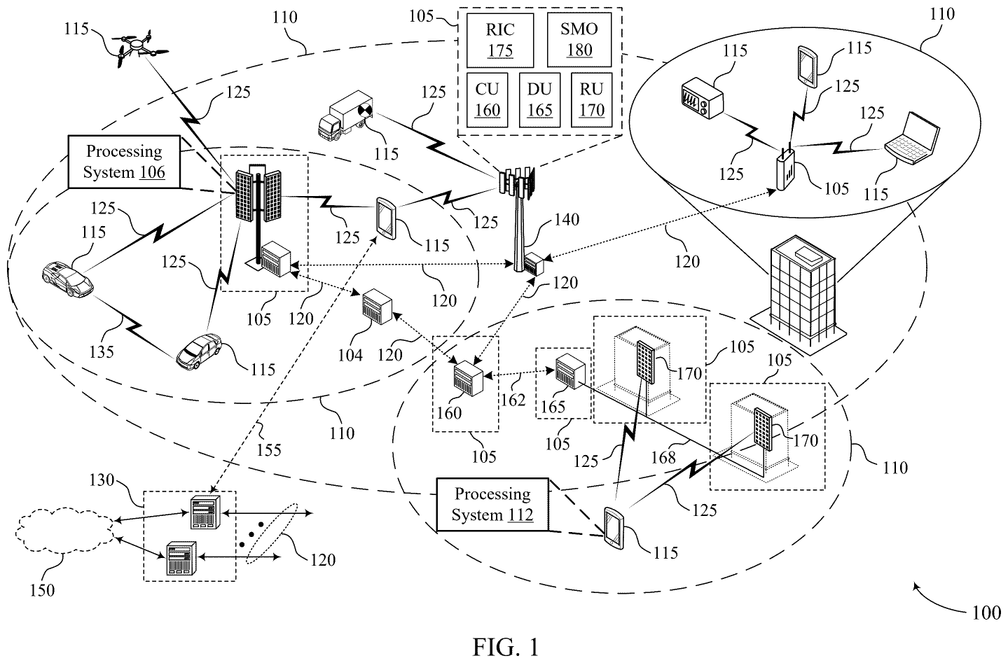

FIG. 1 shows an example of a wireless communications system 100 that supports incremental redundancy and payload change for feedback in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (cRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support incremental redundancy and payload change for feedback as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 115 may transmit HARQ feedback via an uplink control channel, such as a physical uplink control channel (PUCCH). For example, a network entity 105 may transmit DCI via a downlink control channel, such as a physical downlink control channel (PDCCH), to schedule the UE 115 to receive a downlink data information via a downlink shared channel, such as a physical downlink shared channel (PDSCH). The DCI may include resource allocation information for the PDSCH and indicate a slot offset to the PUCCH for the HARQ feedback.

In some examples, the DCI may include a parameter that indicates the slot offset to the PUCCH for the HARQ feedback. For example, a slot offset from a PDSCH slot to an uplink slot for HARQ feedback may be denoted by k₁. In some examples, the DCI may indicate a value for k₁. For example, one value of k₁ may be indicated by the DCI scheduling the PDSCH. In some cases, if there is only one k₁ value to indicate, the one k₁ value may be configured via RRC signaling (e.g., without indication in DCI). In some cases, RRC signaling may configure a set of possible k₁ values from which one k₁ value is indicated by the DCI. If the DCI does not schedule a PDSCH but triggers HARQ feedback, k₁ may correspond to a slot offset from a PDCCH slot carrying the DCI to the PUCCH slot for HARQ feedback.

A UE 115 may determine a codebook via semi-static information based on candidate PDSCH occasions. In some cases, the UE 115 may not consider PDCCH monitoring occasions for a Type 1 HARQ feedback codebook. The set of PDSCH occasions may be determine on a per-downlink serving cell basis. A set of configured K₁ values may correspond to possible slot timing offset values, or offsets between a PDSCH slot and a slot where the UE 115 transmits HARQ feedback. Downlink control information may indicate one slot timing offset value, k₁, from the set of slot timing offset values K₁. For each K₁ value, PDSCH time domain resource allocation (TDRA) candidates that overlap with semi-static uplink symbols may be removed from a set of PDSCH time domain resource allocation (TDRA) candidates corresponding to a start and length indicator value (SLIV) in a slot. The remaining TDRA candidates or row may be grouped such that a quantity of groups is a maximum quantity of non-overlapping SLIVs in the slot. For example, the UE 115 may first perform PDSCH occasion determination and second perform HARQ-ACK codebook determination based on the PDSCH occasions.

The parameter k₁ may be selected from a set of possible slot offset or k₁ values, which may be referred to as K₁. The set of slot offsets, K₁, may be configured via RRC signaling, such as in a parameter dl-DataToUL-Ack. A PDSCH to HARQ feedback timing indicator field in DCI may indicate the slot offset k₁ through [log₂|K1|] bits. For fallback DCI, or DCI with a format 1_0, K₁ may include {1,2,3,4,5,6,7,8}, and three bits in DCI may indicate one of the eight values for k₁.

If a subcarrier spacing (SCS) of the PDSCH and the PUCCH cells are different, k₁ may be counted with respect to a numerology of the PUCCH cell. A reference slot to begin counting may be the last uplink slot (e.g., in the PUCCH cell) that overlaps with the downlink slot containing the PDSCH, or the PDCCH in case the DCI does not schedule PDSCH.

For a PUCCH cell in a time division duplex (TDD) system, a network entity 105 may schedule HARQ feedback in a next unused special or uplink slot which satisfies the PDSCH processing timeline. In a first example, a TDD pattern may be {D, D, D, S, U, D, D, D, S, U}, where D corresponds to a downlink slot, S corresponds to a special slot (e.g., including uplink symbols or downlink symbols, or both), and U corresponds to an uplink slot. Downlink control information in any of the first three downlink slots (e.g., slots 0 through 2) may indicate a slot offset pointing to the first uplink slot (e.g., slot 4) for HARQ feedback, and DCI in the first special slot or any of the later three downlink slots (e.g., slots 5 through 7) may indicate a slot offset pointing the second uplink slot (e.g., slot 9) for HARQ feedback. For example, DCI slot 0 and slot 5 may each indicate a k₁ of 4, DCI in slot 1 and slot 6 may each indicate a k₁ of 3, DCI in slot 2 and 7 may each indicate a k₁ of 2, and DCI in slot 3 may indicate a k₁ of 6. In this example, K₁ may include {6, 4, 3, 2}, and k₁ may be indicated by two bits in DCI.

In a second example, the TDD pattern may be {D, D, D, D, D, D, D, S, U, U}. In this example, DCI in each downlink slot (e.g., slots 0 through 6) may point to the first uplink slot (slot 8), and DCI in the special slot (slot 7) may point to the second uplink slot (slot 9). The set of slot offsets, K₁, for this TDD pattern may include {8, 7, 6, 5, 4, 3, 2}, and one of them (e.g., k₁) may be indicated using three bits in DCI.

In some cases, a UE 115 may be semi-statically or dynamically configured to transmit uplink control information over multiple PUCCH repetitions. The UE may use a same PUCCH resource across multiple slots or sub-slots. For a semi-static configuration of PUCCH repetition, a quantity of repetitions, N, may be configured as part of, or with, PUCCH formats. For example, a parameter, such as nrofSlots in a PUCCH-FormatConfig field, may indicate the quantity of repetitions for PUCCH repetition. PUCCH transmissions with the same format may use the same quantity of repetitions for PUCCH repetition. For dynamic configuration of PUCCH repetition, the quantity of repetitions may be configured per-PUCCH resource. A physical resource indicator may implicitly and dynamically indicate the quantity of repetitions, such as by pointing to a PUCCH resource that is RRC configured to be associated with a certain quantity of repetitions. Repetition counting toward N, the quantity of repetitions, may be based on available slot counting. A slot in which the symbols of the PUCCH resource overlap with semi-static downlink resources or synchronization signal block (SSB) symbols may not be counted toward the N repetitions.

Some systems may implement restrictions for PUCCH repetition. For example, some systems may implement a first restriction to not support uplink control information multiplexing on a PUSCH. If a PUCCH repetition overlaps with a PUSCH, in a same or different uplink component carrier, the UE 115 may drop the PUSCH. In some examples, these systems may implement a second restriction to not support uplink control information multiplexing on a PUCCH. If multiple uplink control information are on overlapping resources, and at least one of the uplink control information is configured for PUCCH repetition, the UE 115 may drop PUCCH transmissions according to prioritization rules. For example, the UE 115 may drop lower priority PUCCH transmissions if multiple PUCCH transmissions would overlap in at least one slot, or the UE 115 may drop later PUCCH transmissions if overlapping PUCCH transmissions have a same priority.

These restrictions may ensure a same payload and same coded bits are transmitted in different PUCCH repetitions for soft combining at the network. For the first restriction, even if the same payload is separately encoded and multiplexed on a PUSCH, the UE 115 may use a same mother code with uplink control information (UCI) is multiplexed on different PUSCHs, which is complex as the mother code may be based on multiple factors including PUSCH resources, beta offset, presence, size, and beta offset of other uplink control information multiplexed on the same PUSCH, and the like. For the second restriction, the mother code may need to be the same, but the uplink control information may also be separately encoded on a PUCCH resource. For example, a UE 115 may transmit first and second repetitions of a first uplink control information and first and second repetitions of a second uplink control information, where the second repetition of the first uplink control information and the first repetition of the second uplink control information overlap. In some current systems, the UE 115 may drop the first repetition of the second uplink control information. Without the second restriction or dropping the first repetition of the second uplink control information, the UE may separately encode the second repetition of the first uplink control information and the first repetition of the second uplink control information and transmit the second repetition of the first uplink control information and the first repetition of the second uplink control information on a same PUCCH resource, while ensuring that the mother code length remains the same for the different uplink control information across different repetitions after uplink control information multiplexing.

These restrictions may prevent PUCCH repetition from being flexible. However, even if the restrictions are relaxed, the network may either not schedule PDSCH in some of the downlink slots, impacting downlink throughput, or schedule HARQ feedback with delay to accommodate previous PUCCH repetitions.

The wireless communications system 100 supports techniques for a UE 115 to report HARQ feedback for a PDSCH in multiple HARQ-ACK payloads transmitted on different slots. The HARQ-ACK payloads may include some common information but may be different across the different slots. For example, the UE 115 may transmit HARQ feedback with incremental redundancy by incrementally changing the contents of a HARQ payload across PUCCH transmission occasions. Additional techniques are described for determining PUCCH slots for reporting a HARQ-ACK bit for a given PDSCH on the two or more PUCCH transmission occasions, multiplexing PUCCH with PUSCH and other uplink control information, determining a HARQ codebook for HARQ feedback with incremental redundancy, reporting capability information for HARQ feedback with incremental redundancy, and jointly decoding the HARQ feedback.

Some techniques may be based on available slots or slots that are available for uplink transmission. In some examples, a slot may be an available uplink slot if the slot includes at least one uplink symbol or at least one flexible symbol. In some examples, a slot may be an available uplink slot if all symbols of the slot are uplink symbols or flexible symbols (or a combination of uplink symbols and flexible symbols). In some examples, a slot may be an available uplink slot if all symbols of the PUCCH resource (e.g., that carries HARQ feedback) in that slot are either uplink symbols or flexible symbols.

Criteria for an available uplink slot may be configurable. For example, a network entity 105 may configure a UE 115 to consider a slot as available for uplink transmission if the slot includes one or more uplink or flexible symbols. In some examples, a slot may be considered as available for uplink transmission based on whether the slot at least partially overlaps with an SSB transmission, such as in addition to other criteria. For example, a UE 115 may determine a slot is available for uplink transmission if the slot includes at least one uplink symbol or flexible symbol that does not overlap with SSB transmission, or the UE 115 may determine a slot is available for uplink transmission if it includes all uplink symbols or all flexible symbols, and none of the symbols of the slot overlap with SSB transmission.

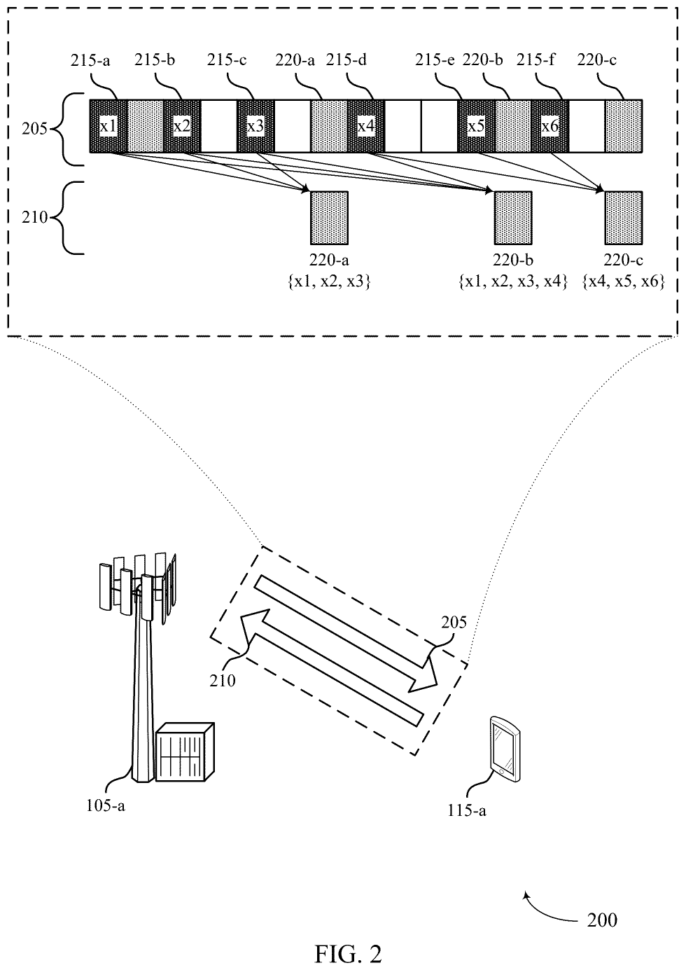

FIG. 2 shows an example of a wireless communications system 200 that supports incremental redundancy and payload change for feedback in accordance with one or more aspects of the present disclosure. The wireless communications system 200 may implement aspects of the wireless communications system 100. For example, the wireless communications system 200 may include a UE 115-a and a network entity 105-a, which may be respective examples of a UE 115 and a network entity 105 described herein.

The UE 115-a may be configured with a downlink cell 205 and an uplink cell 210. The network entity 105-a may transmit downlink signaling, such as downlink shared channel signaling and downlink control channel signaling, to the UE 115-a via the downlink cell 205. The UE 115-a may transmit uplink signaling, such as uplink control channel signaling and uplink shared channel signaling, to the network entity 105-a via the uplink cell 210. The downlink cell 205 and the uplink cell 210 may be configured for TDD communications, where a slot is configured for downlink communications (e.g., a downlink slot 215) or uplink communications (e.g., an uplink slot 220).

The network entity 105-a may transmit downlink data information to the UE 115-a via a downlink shared channel during a downlink slot 215. For example, the network entity 105-a may transmit first downlink data information, including ACK or NACK information (e.g., x₁), to the UE 115-a during a downlink slot 215-a. The UE 115-a may transmit feedback information for the first downlink data information during an uplink slot 220 via the uplink cell 210.

The wireless communications system 200 may support HARQ-ACK bit redundancy, where the UE 115-a reports a HARQ-ACK bit using two or more PUCCH transmission occasions. For example, the UE 115-a may report a HARQ-ACK bit N times across N different PUCCH transmission occasions, where N is two or more. Payloads reported in two different PUCCH transmission occasions may be overlapping, or including at least some common information or some common HARQ-ACK bits, but the payloads in the different PUCCH transmission occasions may not be identical.

For example, the UE 115-a may receive downlink data via PDSCH on the downlink cell 205 during the downlink slot 215-a, a downlink slot 215-b, and a downlink slot 215-c. The UE 115-a may transmit a first uplink control information message via PUCCH on the uplink cell 210 during an uplink slot 220-a. A first payload of the first uplink control information message may indicate HARQ-ACK feedback for the PDSCH received during the downlink slots 215. For example, the first payload may include a first HARQ-ACK bit (x₁) corresponding to the downlink slot 215-a, a second HARQ-ACK bit (x₂) corresponding to the downlink slot 215-b, and a third HARQ-ACK bit (x₃) corresponding to the downlink slot 215-c. That is, the first payload of a first PUCCH on the uplink slot 220-a may include HARQ-ACK bits {x₁, x₂, x₃}.

The UE 115-a may receive downlink data via PDSCH on the downlink cell during a downlink slot 215-d. The UE 115-a may transmit a second uplink control information message via PUCCH on the uplink cell 210 during an uplink slot 220-b. A second uplink payload of the second uplink control information message may include a fourth HARQ-ACK bit (x₄) corresponding to the downlink slot 215-c. The second uplink payload may also include at least a portion of the first uplink payload. For example, the second uplink payload may also include the first, second, and third HARQ-ACK bits (e.g., x₁, x₂, x₃). That is, the second payload of a second PUCCH on the uplink slot 220-b may include HARQ-ACK bits {x₁, x₂, x₃, x₄}, where HARQ-ACK bits x₁, x₂, and x₃ are each transmitted twice, with a first transmission on the first PUCCH and a second transmission on the second PUCCH.

Similarly, the fourth HARQ-ACK bit may be transmitted twice, with a first transmission on the second PUCCH and a third transmission on a third PUCCH during an uplink slot 220-c. If the fourth HARQ-ACK bit corresponds to slot n, the fourth HARQ-ACK bit may be reported in slot n+4 and slot n+7 on the second PUCCH and the third PUCCH, respectively. The third PUCCH during the uplink slot 220-c may include first reports of a fifth HARQ-ACK bit (x₅) and a sixth HARQ-ACK bit (x₆) received via PDSCH during a downlink slot 215-c and a downlink slot 215-f, respectively. For example, the fourth HARQ-ACK bit may be common between a second payload of the second PUCCH and a third payload of the third PUCCH, while the other HARQ-ACK bits of the two payloads may be different.

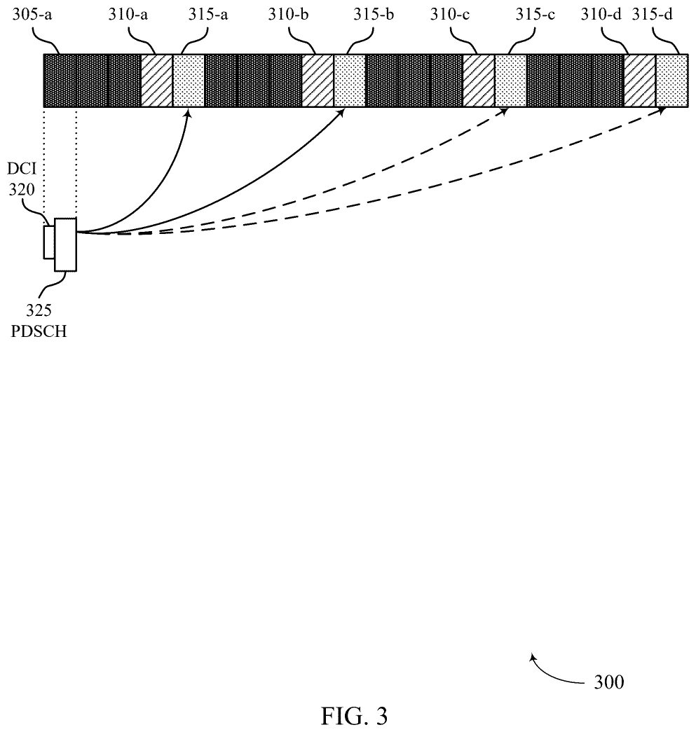

In some examples, the UE 115-a may determine N slots for reporting a HARQ-ACK bit for a given PDSCH on two or more PUCCH transmission occasions. A first slot may be based on a K₁ slot offset indicator in DCI. In some cases, such as in some TDD systems, the remaining N−1 slots may be based on slots that are considered available, or do not overlap with semi-static downlink symbols or SSB symbols. An example of an available slot or a slot that is available for uplink transmission is described in more detail with reference to FIG. 1. An example of identifying PUCCH transmission occasions based on available slots for uplink transmission is described in more detail with reference to FIG. 3.

In some examples, the network entity 105-a may transmit control signaling to the UE 115-a to indicate a value for N. The network entity 105-a may configure the value for N via RRC signaling. In some examples, the value for N may be configured per downlink component carrier, per PUCCH component carrier, per PUCCH format, or per PUCCH resource. For example, if N is configured per downlink component carrier, a first downlink component carrier and a second downlink component carrier may be configured to have different values of N. For example, the UE 115-a may report a HARQ-ACK bit for a PDSCH received via the first downlink component carrier N1 times and report a HARQ-ACK bit for a PDSCH received via the second downlink component carrier N2 times. If N is configured per PUCCH component carrier, all downlink component carriers with HARQ-ACK bits report on a same PUCCH component carrier may have a same N value.

In some examples, the value for N may be configured via MAC information, such as a MAC control element (CE). The network entity 105-a may transmit a MAC CE to indicate or change the value for N for HARQ-ACK reporting per downlink component carrier, PUCCH CC, or both. In some examples, DCI may indicate the value for N. For example, the network entity 105-a may transmit DCI to schedule a PDSCH transmission, and the DCI may indicate a value for N, or a quantity of times the UE 115-a is to report a HARQ-ACK bit for the PDSCH transmission across different PUCCH transmission occasions. For example, the network entity 105-a may dynamically indicate different N for different PDSCHs.

In some examples, DCI may indicate multiple slot offsets. For example, DCI scheduling a PDSCH may indicate N slot offsets, corresponding to the N PUCCH transmission occasions the UE 115-a transmits on to indicate HARQ-ACK feedback for the PDSCH. In some examples, DCI may include N k₁ slot offset indicator fields. For example, PDSCH received in the downlink slot 215-d may be scheduled by DCI that indicates a first k₁ value of 4 and a second k₁ value of 7. The UE 115-a may transmit HARQ-ACK feedback (x₄) for the PDSCH during a PUCCH transmission occasion this is 4 slots after the downlink slot 215-d during the uplink slot 220-b and 7 slots after the downlink slot 215-d during the uplink slot 220-c. In some examples, RRC signaling may configure a corresponding set of slot offset values for each of the slot offset indicator fields separately (e.g., for N=2, the network entity 105-a may configure a first set of K₁ values associated with the first slot offset field and a second set of K₁ values associated with a second slot offset field).

In some examples, DCI may indicate a reserved value if the HARQ-ACK bit is not transmitted. For example, the DCI may include four slot offset indicator fields, but the network entity 105-a may configure the UE 115-a to transmit a HARQ-ACK feedback bit for a PDSCH twice. Values for the third and fourth slot offset indicator fields may be set to a particular or reserved value to indicate that the UE 115-a is not transmit the HARQ-ACK feedback bit a third and fourth time.

In some examples, DCI may include a single slot offset indicator field which jointly indicates multiple slot offsets. For example, the value of the slot offset indicator field, or joint slot offset indicator field, may correspond to a table including multiple slot offset values. An example of a table that maps a joint slot offset indicator field to multiple slot offsets is provided below in Table 1.

TABLE 1

| Value of Joint | First Slot | Second Slot | Third Slot | Fourth Slot |
|---|---|---|---|---|
| Field | Offset | Offset | Offset | Offset |
| 0 | 4 | 9 | None | None |
| 1 | 4 | 9 | 14 | 19 |
| 2 | 2 | 7 | None | None |
| . . . | . . . | . . . | . . . | . . . |

For example, DCI that indicates a 0 in the slot offset indicator field may correspond to a first slot offset of four slots and a second slot offset of nine slots. In some examples, different codepoints or values may be mapped to different slot offsets, different quantities of slot offsets or different N values, or both. For example, the network entity 105-a may configure the UE 115-a with a table, such as Table 1, that maps values of a joint slot offset indicator field to multiple slot offsets. The network entity 105-a may configure the table or mapping via RRC signaling and indicate a value for the joint slot offset indicator via DCI.

In an aspect, the UE 115-a may receive DCI scheduling a PDSCH in slot n. The joint slot offset indicator field in the DCI may have a value of zero, and the UE 115-a may use a lookup table to identify slot offsets that correspond to the joint slot offset indicator field having a value of 0. The UE 115-a may determine a first PUCCH transmission occasion in slot n+4 for transmitting a first instance of HARQ-ACK feedback for the PDSCH and a second PUCCH transmission occasion in slot n+9 for transmitting a second instance of HARQ-ACK feedback for the PDSCH.

The first slot offset may be with respect to a slot carrying the PDSCH. For example, a first slot offset value of two may correspond to first transmission of HARQ-ACK feedback for the PDSCH in a first uplink slot that is two slots after a downlink slot carrying the PDSCH. In some examples, other slot offsets may be with respect to the slot carrying the PDSCH slot. For example, a second slot offset value of 4 may correspond to second transmission of HARQ-ACK feedback for the PDSCH in a second uplink slot that is four slots after the downlink slot carrying the PDSCH. In this example, the second slot offset may be larger than the first slot offset, and the third slot offset may be larger than the second slot offset, and so on. In some other examples, non-initial slot offsets may be with respect to the previous slot on which the HARQ-ACK bit was report. For example, if the second slot offset value is four, the UE 115-a may transmit the HARQ-ACK bit in a second PUCCH transmission occasion that is four slots after the first PUCCH transmission occasion. With a first slot offset value of two, the HARQ-ACK bit for the PDSCH may be transmitted for a second time in a PUCCH occasion that is six slots after the first PUCCH transmission occasion.

In some examples, DCI may indicate multiple slot offsets based on available slots for uplink transmission. For example, only slots which are available for uplink transmission, that is slots which do not overlap with semi-static downlink symbols or SSB symbols, may be counted toward the slot offset. Counting according to available slots for uplink transmission may correspond to smaller slot offsets and reduced overhead.

The network entity 105-a may configure the UE 115-a with a Type-I HARQ-ACK codebook. A K₁ window associated with HARQ-ACK reporting in slot n may include all possible PDSCH reception occasions whose HARQ-ACK can be reported in slot n. A PDSCH slot n−k₁ may be considered for Type-I HARQ-ACK codebook construction in slot n if slot n can be indicated as one of the N HARQ-ACK reporting occasions for a hypothetical PDSCH scheduled in slot n−k₁. These candidate PDSCH slots may be determined semi-statically and irrespective of actual PDSCH scheduling. However, the signaling techniques to indicate the slot offsets, scheduling, and the like may impact the possible candidate PDSCH slots. The candidate PDSCH slots may correspond to a size of the Type-I HARQ-ACK codebook.

In some examples, the UE 115-a may transmit a capability report indicating capability information associated with HARQ-ACK bit redundancy. The UE 115-a may indicate a threshold N value via capability signaling. For example, the UE 115-a may report a maximum quantity of slots or PUCCH transmission occasions, N, for which the UE 115-a can be requested to report HARQ-ACK for a given PDSCH. A larger N value may correspond to more UE processing, as larger N values may result in larger payload sizes for HARQ-ACK reporting the same quantity of scheduled PDSCHs.

In some examples, the capability report may indicate a threshold time that the UE 115-a can keep or buffer a HARQ-ACK bit for a given PDSCH. For example, the UE 115-a may indicate a maximum duration that the UE 115-a can buffer a HARQ-ACK bit for a given PDSCH. In some examples, the threshold time or duration may be indicated as a quantity of slots after the PDSCH slot, corresponding to a difference between the PDSCH slot and a last slot on which the UE 115-a can report the HARQ-ACK bit for the PDSCH slot. In some examples, the threshold time or duration may be indicated as a quantity of slots after the first slot on which the HARQ-ACK bit is reported, corresponding to a difference between the first slot the HARQ-ACK bit is reported and a last slot on which the HARQ-ACK bit can be report. A larger maximum time or threshold duration may correspond to a UE 115 using more memory, as the UE 115 may buffer or memorize the HARQ-ACK bit for a longer duration.

The network entity 105-a may receive multiple PUCCH payloads indicating multiple HARQ-ACK bits for multiple PDSCH. The network entity 105-a may consider two or more of the PUCCH payloads jointly to decode the HARQ-ACK bits. In some examples, the network entity 105-a may jointly decode multiple PUCCHs. For example, to decode HARQ-ACK bit xᵢ, all PUCCH payloads including xi may be used together. For example, to decode {x₁, x₂, x₃}, the network entity 105-a may decode the first PUCCH payload received on the uplink slot 220-a and the second PUCCH payload received on the uplink slot 220-b. Similarly, to decode {x₄}, the network entity 105-a may decode the second PUCCH payload with the third PUCCH payload.

In some examples, the network entity 105-a may sequentially aggregate PUCCHs until successful decoding of a HARQ-ACK bit. For example, the network entity 105-a may attempt to decode {x₁, x₂, x₃} from the first PUCCH payload. If decoding of the first PUCCH payload is unsuccessful, the network entity 105-a may attempt to decode {x₁, x₂, x₃, x₄} from both the first PUCCH payload and the second PUCCH payload. If this decoding is unsuccessful, the network entity 105-a may attempt to decode {x₁, x₂, x₃, x₄, x₅, x₆} from the first PUCCH payload, the second PUCCH payload, and the third PUCCH payload. When decoding is successful, the network entity 105-a may reset the decoding process for future PUCCH payloads.

In some examples, the network entity 105-a may perform separate decoding with forward and backward propagation. For example, the network entity 105-a may attempt decoding each PUCCH separately. If the decoding is successful, the network entity 105-a may attempt to decode either a next PUCCH or a previous PUCCH, using decoding information obtained from common HARQ-ACK bits. For example, the network entity 105-a may successfully decode the third PUCCH payload including {x₄, x₅, x₆}. The network entity 105-a may use side information on {x₄} to decode the second PUCCH payload of the second PUCCH, as x₄ is also include in the second PUCCH payload of {x₁, x₂, x₃, x₄}. Additionally, or alternatively, the network entity 105-a may use side information on {x₅, x₆} to decode a fourth PUCCH. For example, the UE 115-a may transmit a fourth PUCCH payload indicating HARQ-ACK bits for PDSCHs {x₅, x₆, x₇, x₈}. The side information may correspond to hard-decisions of common bits. For example, a decoded value of {x₄, x₅, x₆} may each correspond to a +1 or −1. Or, the side information may be a soft decoding metric based on a likelihood or a reliability for each bit being +1 or −1. Side information may also be utilized for sequential aggregation decoding or joint decoding, or both. In some examples, the network entity 105-a may enable or disable decoding based on joint PUCCHs based on a max size of a HARQ-ACK payload or a coding scheme. For example, joint decoding or using side information may be implemented for Reed-Muller code, which may be suitable for smaller-sized payloads.

FIG. 3 shows an example of a slot offset indication scheme 300 that supports incremental redundancy and payload change for feedback in accordance with one or more aspects of the present disclosure. The slot offset indication scheme 300 may implement aspects of a wireless communications system 100 or 200.

The slot offset indication scheme 300 may be implemented in a wireless communications system that supports HARQ-ACK bit redundancy. The wireless communications system may support TDD communications, where a cell includes downlink slots 305, special slots 310, and uplink slots 315. A special slot may include uplink symbols, downlink symbols, or both.

For HARQ-ACK bit redundancy, a UE may report a HARQ-ACK bit for a PDSCH, received from a network entity in a downlink slot 305, using two or more PUCCH transmission occasions in two or more respective uplink slots 315. The UE may report a HARQ-ACK bit N times across N different PUCCH transmission occasions, where N is two or more. Payloads reported in two different PUCCH transmission occasions may be overlapping, or including at least some common information or some common HARQ-ACK bits, but the payloads in the different PUCCH transmission occasions may not be identical.

For example, the UE may receive a DCI 320. The DCI 320 may schedule a PDSCH 325 used to transmit downlink data information to the UE. The UE may transmit a HARQ-ACK bit for the PDSCH in N PUCCH transmission occasions, corresponding to N uplink slots 315 or N slots that are available for uplink transmission. The DCI 320 and the PDSCH 325 may be received during a downlink slot 305-a.

In some examples, the slot offsets for the N uplink slots may be based on slots that are available for uplink transmission. For example, a first slot for a first transmission of the HARQ-ACK bit for the PDSCH 325 may be based on a K₁ slot offset indicator in the DCI 320. The K₁ slot offset may have a value of 4, and the UE may transmit a first PUCCH payload including the HARQ-ACK bit for the PDSCH 325 on a first PUCCH transmission occasion during an uplink slot 315-a. In this example, the DCI 320 may be indicative of a single slot offset.

The remaining N−1 slots may be based on slots that are considered available, or do not overlap with semi-static downlink symbols or SSB symbols. For example, an uplink slot 315-b may be the next slot that is available for uplink transmission, and the UE may transmit a second PUCCH payload including the HARQ-ACK bit for the PDSCH 325 on a second PUCCH transmission occasion during the uplink slot 315-b. The first PUCCH payload and the second PUCCH payload may include partially common information, such as the HARQ-ACK bit for the PDSCH 325, but the first PUCCH payload and the second PUCCH payload may not be the same or identical. An uplink slot 315-c may be a next slot that is available for uplink transmission, and the UE may transmit a third PUCCH payload including the HARQ-ACK bit for the PDSCH 325 on a third PUCCH transmission occasion during the uplink slot 315-c.

The network entity may indicate a value for N when the remaining N−1 slots are based on available slots. The network entity may transmit RRC signaling, a MAC CE, or DCI to indicate an N value for one or more PDSCHs. For example, the network entity may RRC-configure an N value for a downlink component carrier, a PUCCH component carrier, a PUCCH format, or a PUCCH resource, or any combination thereof. In this example, N has a value of 3.

In some examples, the DCI 320 may be indicative of multiple slot offsets. The DCI 320 may explicitly indicate N slot offsets via N k₁ slot offset indicator fields in the DCI 320. Additionally, or alternatively, the DCI 320 may include a joint slot offset indicator. Each value of the joint slot offset indicator may map to a set of slot offset values. The network entity may configure the UE with a table, where sets of slot offset values are mapped to different joint slot offset indicator values. By indicating a single joint slot offset indicator value, the network entity may indicate multiple slot offsets to the UE. In some examples, the sets of slots offset values may correspond to common slot TDD patterns.

In some examples, the slot offsets indicated by the DCI 320 may be with respect to the downlink slot 305-a carrying the PDSCH 325. In some other examples, the slot offsets indicated by the DCI 320 may be respect to a previous slot on which the same HARQ-ACK bit was reported.

In a first example, the DCI 320 may indicate slot offsets based on physical slots and with respect to the downlink slot 305-a. The DCI may indicate three k₁ values of {4, 9, 19}. The first k₁ value, four, may correspond to an uplink slot 315-a, and the UE may transmit a HARQ-ACK bit for the PDSCH 325 on a first PUCCH transmission occasion. The second k₁ value, nine, may correspond to an uplink slot 315-b, and the UE may transmit a HARQ-ACK bit for the PDSCH 325 on a second PUCCH transmission occasion. The third k₁ value, 19, may correspond to an uplink slot 315-d, and the UE may transmit a HARQ-ACK bit for the PDSCH 325 on a third PUCCH transmission occasion. If the DCI in this example were to be with respect to the previous PUCCH transmission occasion carrying the HARQ-ACK bit for the PDSCH 325, the three k₁ values would be {4, 5, 10}, as the uplink slot 315-b has five slots after the uplink slot 315-a, and the uplink slot 315-c is ten slots after the uplink slot 315-b.

In a second example, the DCI 320 may indicate slot offsets based on available uplink slots and with respect to the downlink slot 305-a. The DCI may indicate three k₁ values of {2, 4, 8}. The first k₁ value, two, may correspond to the uplink slot 315-a, counting both a special slot 310-a and the uplink slot 315-a. The UE may transmit a HARQ-ACK bit for the PDSCH 325 on a first PUCCH transmission occasion during the uplink slot 315-a. The second k₁ value, four, may correspond to the uplink slot 315-b, counting the previous available uplink slots and a special slot 310-b. The UE may transmit a HARQ-ACK bit for the PDSCH 325 on a second PUCCH transmission occasion during the uplink slot 315-b. The third k₁ value, 8, may correspond to the uplink slot 315-d, counting the previous available slots, a special slot 310-c, and an uplink slot 315-c. The UE may transmit a HARQ-ACK bit for the PDSCH 325 on a third PUCCH transmission occasion during the uplink slot 315-d. If the DCI in this example were to be with respect to the previous PUCCH transmission occasion carrying the HARQ-ACK bit for the PDSCH 325, the three k₁ values would be {2, 2, 4}, as the uplink slot 315-b is two available slots after the uplink slot 315-a, and the uplink slot 315-c is four available slots after the uplink slot 315-b.

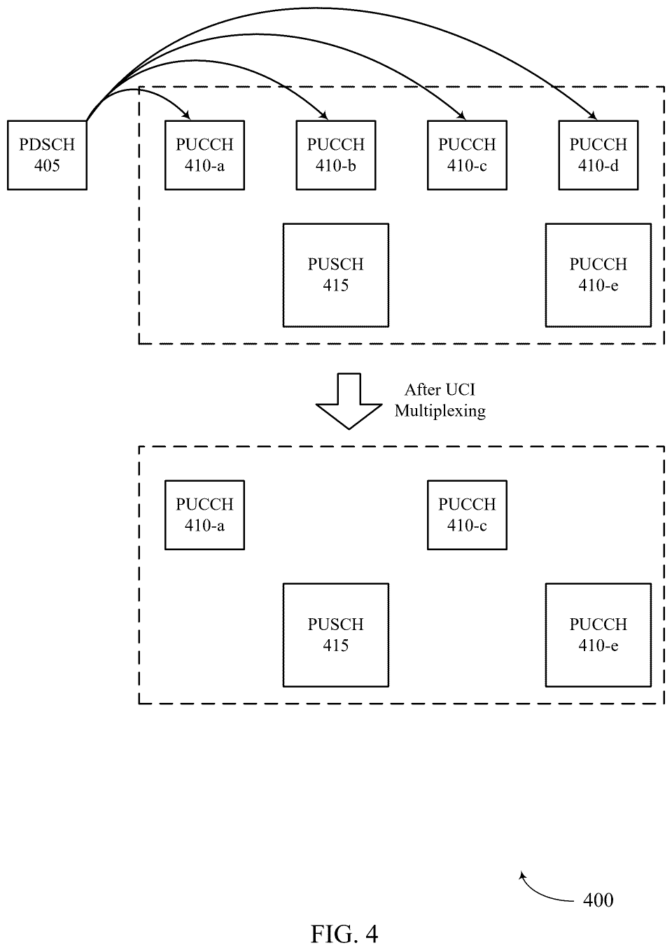

FIG. 4 shows an example of a multiplexing scheme 400 that supports incremental redundancy and payload change for feedback in accordance with one or more aspects of the present disclosure. The multiplexing scheme 400 may implement aspects of a wireless communications system 100 and 200 and a slot offset indication scheme 300.

The multiplexing scheme 400 may be implemented in a wireless communications system that supports HARQ-ACK bit redundancy. The wireless communications system may support TDD communications. A UE may communicate with a network entity using an uplink cell or a downlink cell, or both, according to a TDD pattern.

For HARQ-ACK bit redundancy, a UE may report a HARQ-ACK bit for a PDSCH 405, received from a network entity in a downlink slot, using two or more PUCCH transmission occasions in two or more respective uplink slots. The UE may report a HARQ-ACK bit N times across N different PUCCH transmission occasions, where N is two or more. Payloads reported in two different PUCCH transmission occasions may be overlapping, or including at least some common information or some common HARQ-ACK bits, but the payloads in the different PUCCH transmission occasions may not be identical.

In an aspect, the UE may receive the PDSCH 405 and transmit a HARQ-ACK payload including the HARQ-ACK bit for the PDSCH 405 four times on four PUCCHs 410, including a PUCCH 410-a, a PUCCH 410-b, a PUCCH 410-c, and a PUCCH 410-d. Each PUCCH 410 may correspond to a different PUCCH transmission occasion in a different uplink slot.

If one or more of the N PUCCHs overlap with a PUSCH transmission, the HARQ-ACK payload of the PUCCH transmission may be multiplexed on the PUSCH. The UE may not transmit or may drop the PUCCH transmission. The PUCCH 410-b may overlap with a PUSCH 415. For example, the PUCCH 410-b and the PUSCH 415 may be overlapping in the time domain or in a same uplink slot. The UE may multiplex the HARQ-ACK payload that was to be transmitted on the PUCCH 410-b into the PUSCH 415. After UCI multiplexing, the UE may drop the PUCCH 410-b and transmit the PUSCH 415 including the HARQ-ACK payload of the PUCCH 410-b.

If one or more of the N PUCCHs overlap with another UCI, the HARQ-ACK payload of that PUCCH may be multiplexed with the UCI, and the HARQ-ACK payload and the UCI may be transmitted on a PUCCH resource. For example, the PUCCH 410-d may overlap with a PUCCH 410-e. The PUCCH 410-e may be used to transmit a CSI report or a scheduling request. The UE may drop the PUCCH 410-d and multiplex the HARQ-ACK payload of the PUCCH 410-d with the UCI of the PUCCH 410-c. The UE may transmit the PUCCH 410-c including both the UCI and the HARQ-ACK payload of the PUCCH 410-d.

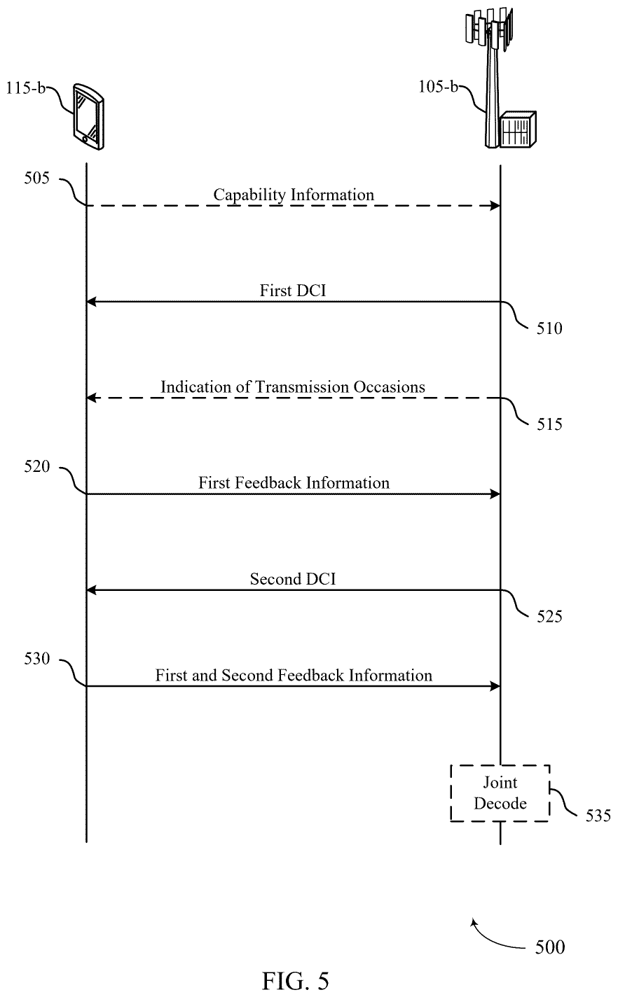

FIG. 5 shows an example of a process flow 500 that supports incremental redundancy and payload change for feedback in accordance with one or more aspects of the present disclosure. The process flow 500 includes a UE 115-b and a network entity 105-b, which may be examples of the corresponding devices as described with respect to FIGS. 1-4. In the following description of the process flow 500, the operations between the UE 115-b and the network entity 105-b may be performed in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505, the UE 115-b may transmit capability information to the network entity 105-b. In some cases, the capability information may be associated with a threshold quantity (e.g., a maximum quantity) of uplink channel transmission occasions that the UE 115-b supports for feedback transmissions. In some examples, the capability information may indicate a threshold quantity (e.g., a maximum quantity) of slots that the network entity supports for buffering feedback information. The threshold quantity of slots may correspond to a quantity of slots after a downlink shared channel. Additionally, or alternatively, the threshold quantity may correspond to a quantity of slots after an initial transmission of feedback information.

At 510, the UE 115-b may receive first DCI that schedules a first set of one or more downlink shared channel transmissions. In some cases, the first DCI may indicate a first slot offset. The first DCI may indicate a quantity of one or more uplink channel transmission occasions to use to transmit feedback, and the quantity may include at least the first uplink channel transmission occasion and a second uplink channel transmission occasion. In some cases, the first DCI may indicate both the first slot offset and a second slot offset. Additionally, or alternatively, the first DCI may indicate a first identifier associated with a set of slot offsets that includes the first slot offset and the second slot offset.

In some implementations, the first slot offset may correspond to a first quantity of one or more slots between a first downlink shared channel transmission of the first set of one or more downlink shared channel transmissions and the first uplink channel transmission occasion. Similarly, the second slot offset may correspond to a second quantity of one or more slots between the first downlink shared channel transmission and the second uplink channel transmission occasion. In some cases, the first slot offset may correspond to a first quantity of one or more slots between a first downlink shared channel transmission of the first set of one or more downlink shared channel transmissions and the first uplink channel transmission occasion. Similarly, the second slot offset may correspond to a second quantity of one or more slots between the first uplink channel transmission occasion and the second uplink channel transmission occasion.

In any case, and as described herein, the UE 115-b may use a slot offset (e.g., the first slot offset or the second slot offset) to determine a next slot to use to transmit feedback information (e.g., one or more HARQ-ACK bits) within a transmission occasion. A “reference slot” may refer to a slot that corresponds to a first downlink transmission or a previous uplink transmission occasion (e.g., the first downlink shared channel transmission or the first uplink channel transmission occasion). A “next slot to be used” may be a slot that corresponds to a target transmission occasion for the feedback information (e.g., the first uplink channel transmission occasion or the second uplink channel transmission occasion). In some implementations, the slot offset may indicate a quantity of slots between the reference slot and the next slot to be used, plus one. For example, if a slot offset indicates four slots, there may be three slots between the reference slot and the next slot. In another example, if the slot offset is equal to one, there may be zero slots between the reference slot and the next slot. In some examples, the slot offset may indicate a count starting at the reference slot and ending at the next slot.

At 515, the UE 115-b may receive signaling that indicates a quantity of one or more uplink channel transmission occasions to use to transmit feedback. The quantity may include at least the first uplink channel transmission occasion and the second uplink channel transmission occasion. The signaling may be or may include RRC signaling, MAC-control element (MAC-CE) signaling, DCI signaling, or a combination thereof. In some cases, the signaling may indicate a respective quantity of one or more uplink channel transmission occasions to use to transmit feedback for each downlink component carrier of a set of one or more downlink component carriers. In some implementations, the signaling may indicate a respective quantity of one or more uplink channel transmission occasions to use to transmit feedback for each uplink component carrier of a set of one or more uplink component carriers. In some examples, the signaling may indicate a respective quantity of one or more uplink channel transmission occasions to use to transmit feedback for each uplink control channel format of a set of one or more uplink control channel formats. Additionally, or alternatively, the signaling may indicate a respective quantity of one or more uplink channel transmission occasions to use to transmit feedback for each uplink control channel resource of a set of one or more uplink control channel resources. At 520, the UE 115-b may transmit, during the first uplink channel transmission occasion based on the first slot offset, first feedback information associated with the first set of one or more downlink shared channel transmissions.

At 525, the UE 115-b may receive second DCI that schedules a second set of one or more downlink shared channel transmissions. At 530, the UE 115-b may transmit the first feedback information and second feedback information in a single payload. For example, the UE 115-b may transmit the single payload during the second uplink channel transmission occasion and based on the second slot offset.

In some cases, the second feedback information may be associated with the second set of one or more downlink shared channel transmissions. In some implementations, to transmit the first feedback information and the second feedback information (e.g., in a single payload), the UE 115-b may multiplex the second feedback information and the first feedback information on a channel (e.g., a shared channel such as a PUSCH) that overlaps with the second uplink channel transmission occasion. In some cases, the UE 115-b may multiplex the second feedback information and the first feedback information with UCI. In such cases, the second uplink channel transmission occasion may overlap with an uplink control channel for the UCI, and the UE 115-b may transmit the UCI with the second feedback information and the first feedback information.

In some examples, the second slot offset may correspond to a quantity of one or more slots relative to a next available slot from a reference slot (e.g., a first slot) corresponding to a first uplink channel transmission occasion. The next available slot may not overlap with an SSB or one or more downlink symbols. In some implementations, the first slot offset and the second slot offset may be a same slot offset.

In some implementations, the second uplink channel transmission occasion may include a feedback slot for a set of downlink shared channels that includes at least a first downlink shared channel transmission of the first set of one or more downlink shared channel transmissions and a second downlink shared channel transmission of the second set of one or more downlink shared channel transmissions. The UE 115-b may determine one or more transmissions of the feedback slot for the second uplink channel transmission occasion based on a difference between a slot index of the feedback slot and the second slot offset.

At 535, the network entity 105-b may jointly decode the first feedback information obtained via the first uplink channel transmission occasion and the first feedback information obtained via the second uplink channel transmission occasion. For example, the network entity 105-b may decode the first feedback information and the second feedback information as part of a single decoding procedure.

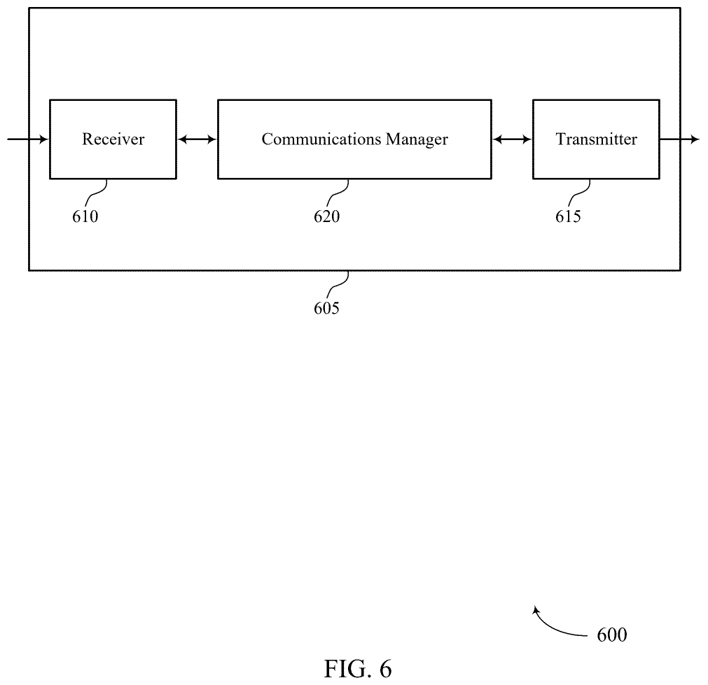

FIG. 6 shows a block diagram 600 of a device 605 that supports incremental redundancy and payload change for feedback in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to incremental redundancy and payload change for feedback). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to incremental redundancy and payload change for feedback). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of incremental redundancy and payload change for feedback as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving first DCI that schedules a first set of one or more downlink shared channel transmissions. The communications manager 620 is capable of, configured to, or operable to support a means for transmitting, during a first uplink channel transmission occasion based on a first slot offset, first feedback information associated with the first set of one or more downlink shared channel transmissions. The communications manager 620 is capable of, configured to, or operable to support a means for receiving second DCI that schedules a second set of one or more downlink shared channel transmissions. The communications manager 620 is capable of, configured to, or operable to support a means for transmitting, during a second uplink channel transmission occasion based on a second slot offset, the first feedback information and second feedback information in a single payload, where the second feedback information is associated with the second set of one or more downlink shared channel transmissions.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for incremental redundancy and payload change for feedback, which may result in reduced processing, reduced power consumption, increased compatibility between devices, reduced channel restrictions, and more efficient utilization of communication resources, among other advantages.

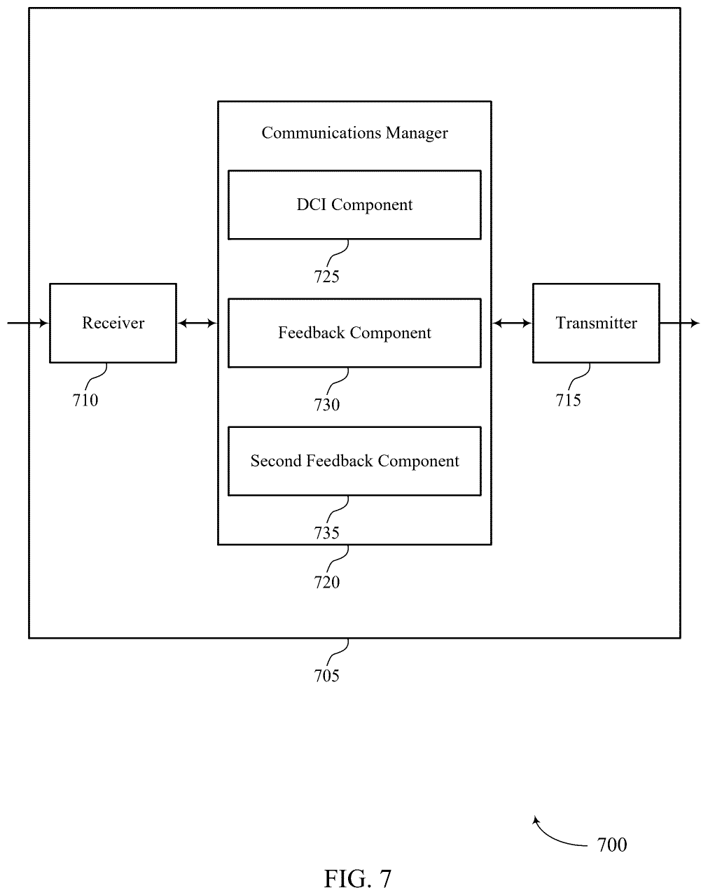

FIG. 7 shows a block diagram 700 of a device 705 that supports incremental redundancy and payload change for feedback in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to incremental redundancy and payload change for feedback). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to incremental redundancy and payload change for feedback). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of incremental redundancy and payload change for feedback as described herein. For example, the communications manager 720 may include a DCI component 725, a feedback component 730, a second feedback component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The DCI component 725 is capable of, configured to, or operable to support a means for receiving first DCI that schedules a first set of one or more downlink shared channel transmissions. The feedback component 730 is capable of, configured to, or operable to support a means for transmitting, during a first uplink channel transmission occasion based on a first slot offset, first feedback information associated with the first set of one or more downlink shared channel transmissions. The DCI component 725 is capable of, configured to, or operable to support a means for receiving second DCI that schedules a second set of one or more downlink shared channel transmissions. The second feedback component 735 is capable of, configured to, or operable to support a means for transmitting, during a second uplink channel transmission occasion based on a second slot offset, the first feedback information and second feedback information in a single payload, where the second feedback information is associated with the second set of one or more downlink shared channel transmissions.

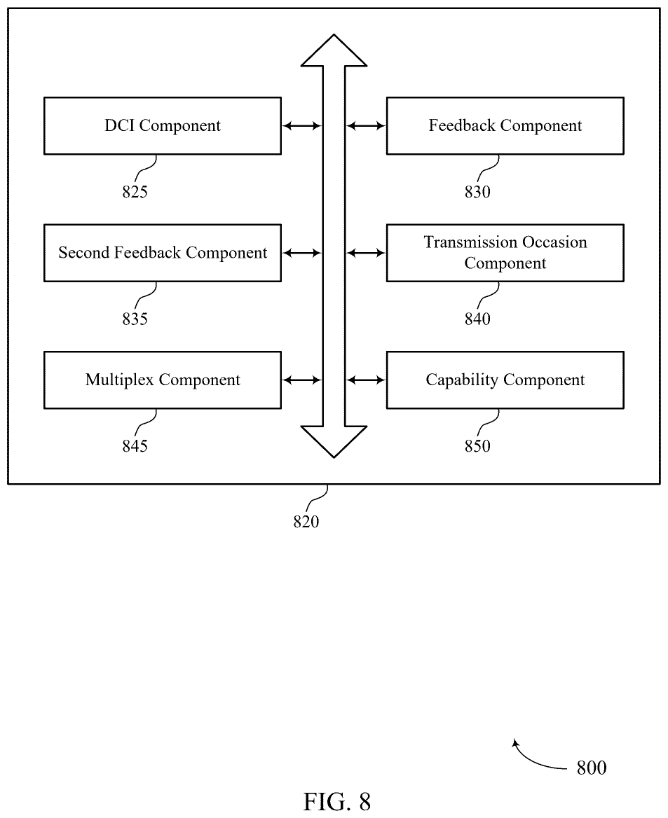

FIG. 8 shows a block diagram 800 of a communications manager 820 that supports incremental redundancy and payload change for feedback in accordance with one or more aspects of the present disclosure. The communications manager 820 may be an example of aspects of a communications manager 620, a communications manager 720, or both, as described herein. The communications manager 820, or various components thereof, may be an example of means for performing various aspects of incremental redundancy and payload change for feedback as described herein. For example, the communications manager 820 may include a DCI component 825, a feedback component 830, a second feedback component 835, a transmission occasion component 840, a multiplex component 845, a capability component 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The DCI component 825 is capable of, configured to, or operable to support a means for receiving first DCI that schedules a first set of one or more downlink shared channel transmissions. The feedback component 830 is capable of, configured to, or operable to support a means for transmitting, during a first uplink channel transmission occasion based on a first slot offset, first feedback information associated with the first set of one or more downlink shared channel transmissions. In some examples, the DCI component 825 is capable of, configured to, or operable to support a means for receiving second DCI that schedules a second set of one or more downlink shared channel transmissions. The second feedback component 835 is capable of, configured to, or operable to support a means for transmitting, during a second uplink channel transmission occasion based on a second slot offset, the first feedback information and second feedback information in a single payload, where the second feedback information is associated with the second set of one or more downlink shared channel transmissions.

In some examples, the first DCI indicates the first slot offset. In some examples, the second slot offset corresponds to a quantity of one or more slots relative to a next available slot from a reference slot corresponding to the first uplink channel transmission occasion.

In some examples, the next available slot does not overlap with a SSB or one or more downlink symbols.

In some examples, the transmission occasion component 840 is capable of, configured to, or operable to support a means for receiving signaling that indicates a quantity of one or more uplink channel transmission occasions to use to transmit feedback, where the quantity includes at least the first uplink channel transmission occasion and the second uplink channel transmission occasion.

In some examples, the signaling indicates a respective quantity of one or more uplink channel transmission occasions to use to transmit feedback for each downlink component carrier of a set of one or more downlink component carriers.

In some examples, the signaling indicates a respective quantity of one or more uplink channel transmission occasions to use to transmit feedback for each uplink component carrier of a set of one or more uplink component carriers.

In some examples, the signaling indicates a respective quantity of one or more uplink channel transmission occasions to use to transmit feedback for each uplink control channel format of a set of one or more uplink control channel formats.

In some examples, the signaling indicates a respective quantity of one or more uplink channel transmission occasions to use to transmit feedback for each uplink control channel resource of a set of one or more uplink control channel resources.

In some examples, the signaling includes RRC signaling, MAC-CE signaling, DCI signaling, or a combination thereof.

In some examples, the first DCI indicates a quantity of one or more uplink channel transmission occasions to use to transmit feedback. In some examples, the quantity includes at least the first uplink channel transmission occasion and the second uplink channel transmission occasion.

In some examples, the first DCI indicates the first slot offset and the second slot offset.

In some examples, the first slot offset and the second slot offset are a same slot offset.

In some examples, the first DCI indicates a first identifier associated with a set of slot offsets. In some examples, the set of slot offsets includes the first slot offset and the second slot offset.

In some examples, the first slot offset corresponds to a first quantity of one or more slots between a first downlink shared channel transmission of the first set of one or more downlink shared channel transmissions and the first uplink channel transmission occasion. In some examples, the second slot offset corresponds to a second quantity of one or more slots between the first downlink shared channel transmission and the second uplink channel transmission occasion.

In some examples, the first slot offset corresponds to a first quantity of one or more slots between a first downlink shared channel transmission of the first set of one or more downlink shared channel transmissions and the first uplink channel transmission occasion. In some examples, the second slot offset corresponds to a second quantity of one or more slots between the first uplink channel transmission occasion and the second uplink channel transmission occasion.

In some examples, to support transmitting the first feedback information and the second feedback information, the multiplex component 845 is capable of, configured to, or operable to support a means for multiplexing the second feedback information and the first feedback information on a channel that overlaps with the second uplink channel transmission occasion.

In some examples, to support transmitting the first feedback information and the second feedback information, the multiplex component 845 is capable of, configured to, or operable to support a means for multiplexing the second feedback information and the first feedback information with uplink control information, where the second uplink channel transmission occasion overlaps with an uplink control channel for the uplink control information, and where the uplink control information is transmitted with the second feedback information and the first feedback information.

In some examples, the second uplink channel transmission occasion includes a feedback slot for a set of downlink shared channels that includes at least a first downlink shared channel transmission of the first set of one or more downlink shared channel transmissions and a second downlink shared channel transmission of the second set of one or more downlink shared channel transmissions based on a difference between a slot index of the feedback slot and the second slot offset.

In some examples, the capability component 850 is capable of, configured to, or operable to support a means for transmitting capability information associated with a threshold quantity of uplink channel transmission occasions that the network entity supports for feedback transmissions.

In some examples, the capability component 850 is capable of, configured to, or operable to support a means for transmitting capability information that indicates a threshold quantity of slots that the network entity supports for buffering feedback information, where the threshold quantity of slots corresponds to a quantity of slots after a downlink shared channel.

In some examples, the capability component 850 is capable of, configured to, or operable to support a means for transmitting capability information that indicates a threshold quantity of slots that the network entity supports for buffering feedback information, where the threshold quantity of slots corresponds to a quantity of slots after an initial transmission of the feedback information.

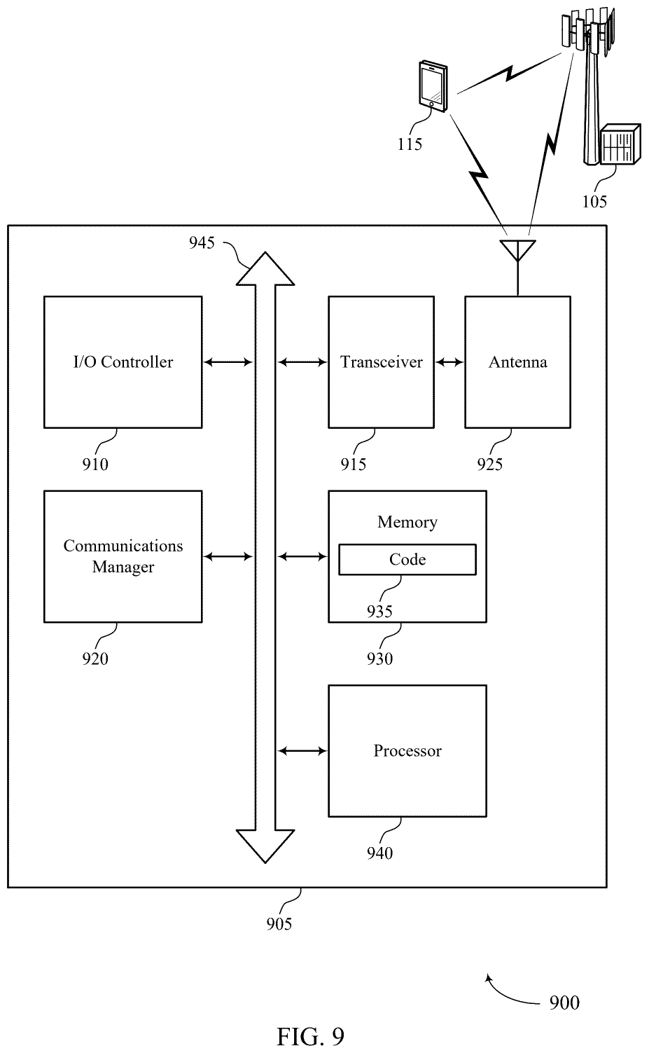

FIG. 9 shows a diagram of a system 900 including a device 905 that supports incremental redundancy and payload change for feedback in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting incremental redundancy and payload change for feedback). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving first DCI that schedules a first set of one or more downlink shared channel transmissions. The communications manager 920 is capable of, configured to, or operable to support a means for transmitting, during a first uplink channel transmission occasion based on a first slot offset, first feedback information associated with the first set of one or more downlink shared channel transmissions. The communications manager 920 is capable of, configured to, or operable to support a means for receiving second DCI that schedules a second set of one or more downlink shared channel transmissions. The communications manager 920 is capable of, configured to, or operable to support a means for transmitting, during a second uplink channel transmission occasion based on a second slot offset, the first feedback information and second feedback information in a single payload, where the second feedback information is associated with the second set of one or more downlink shared channel transmissions.

By including or configuring the communications manager 920 in accordance with examples as described herein, the device 905 may support techniques for incremental redundancy and payload change for feedback, which may result in improved communication reliability, reduced latency, improved user experience related to reduced processing, reduced power consumption, increased compatibility between devices, reduced channel restrictions, improved coordination between devices, and more efficient utilization of communication resources, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of incremental redundancy and payload change for feedback as described herein, or the at least one processor 940 and the at least one memory 930 may be otherwise configured to, individually or collectively, perform or support such operations.

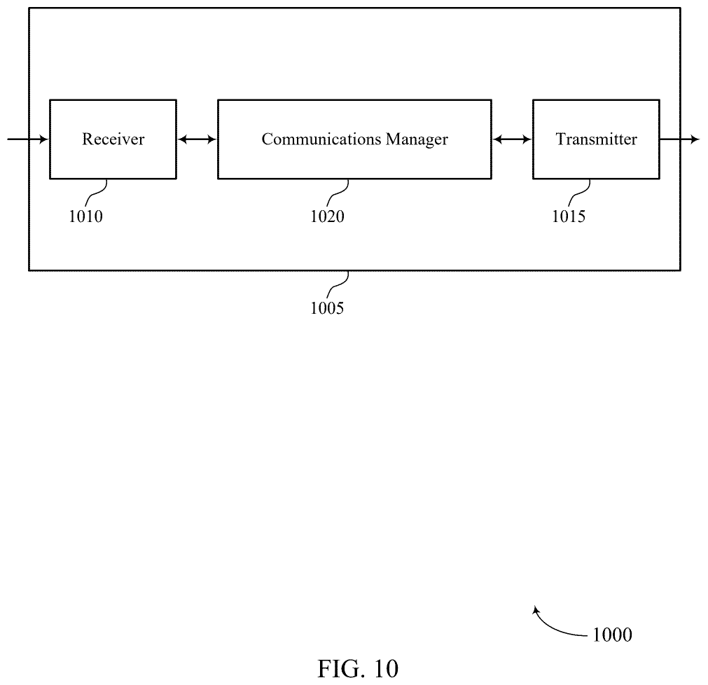

FIG. 10 shows a block diagram 1000 of a device 1005 that supports incremental redundancy and payload change for feedback in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of incremental redundancy and payload change for feedback as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for outputting first DCI that schedules a first set of one or more downlink shared channel transmissions. The communications manager 1020 is capable of, configured to, or operable to support a means for obtaining, during a first uplink channel transmission occasion based on a first slot offset, first feedback information associated with the first set of one or more downlink shared channel transmissions. The communications manager 1020 is capable of, configured to, or operable to support a means for outputting second DCI that schedules a second set of one or more downlink shared channel transmissions. The communications manager 1020 is capable of, configured to, or operable to support a means for obtaining, during a second uplink channel transmission occasion based on a second slot offset, the first feedback information and second feedback information in a single payload, where the second feedback information is associated with the second set of one or more downlink shared channel transmissions.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for incremental redundancy and payload change for feedback, which may result in reduced processing, reduced power consumption, increased compatibility between devices, reduced channel restrictions, and more efficient utilization of communication resources, among other advantages.

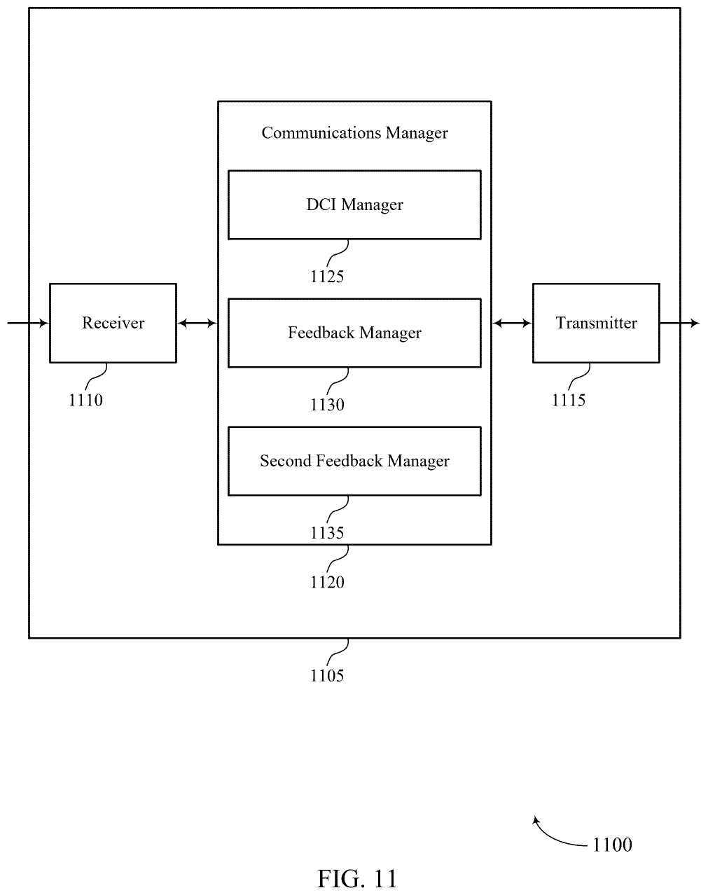

FIG. 11 shows a block diagram 1100 of a device 1105 that supports incremental redundancy and payload change for feedback in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of incremental redundancy and payload change for feedback as described herein. For example, the communications manager 1120 may include a DCI manager 1125, a feedback manager 1130, a second feedback manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The DCI manager 1125 is capable of, configured to, or operable to support a means for outputting first DCI that schedules a first set of one or more downlink shared channel transmissions. The feedback manager 1130 is capable of, configured to, or operable to support a means for obtaining, during a first uplink channel transmission occasion based on a first slot offset, first feedback information associated with the first set of one or more downlink shared channel transmissions. The DCI manager 1125 is capable of, configured to, or operable to support a means for outputting second DCI that schedules a second set of one or more downlink shared channel transmissions. The second feedback manager 1135 is capable of, configured to, or operable to support a means for obtaining, during a second uplink channel transmission occasion based on a second slot offset, the first feedback information and second feedback information in a single payload, where the second feedback information is associated with the second set of one or more downlink shared channel transmissions.

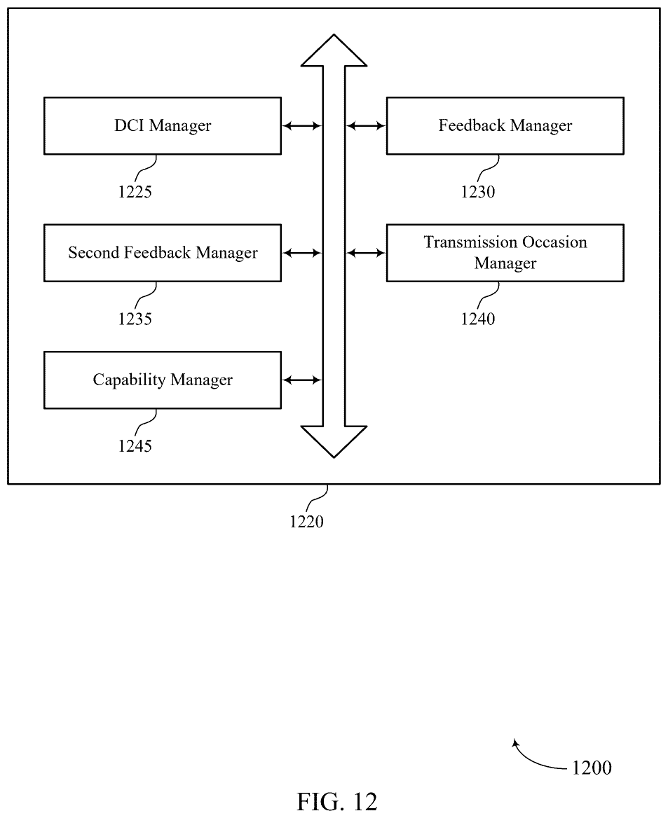

FIG. 12 shows a block diagram 1200 of a communications manager 1220 that supports incremental redundancy and payload change for feedback in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of incremental redundancy and payload change for feedback as described herein. For example, the communications manager 1220 may include a DCI manager 1225, a feedback manager 1230, a second feedback manager 1235, a transmission occasion manager 1240, a capability manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The DCI manager 1225 is capable of, configured to, or operable to support a means for outputting first DCI that schedules a first set of one or more downlink shared channel transmissions. The feedback manager 1230 is capable of, configured to, or operable to support a means for obtaining, during a first uplink channel transmission occasion based on a first slot offset, first feedback information associated with the first set of one or more downlink shared channel transmissions. In some examples, the DCI manager 1225 is capable of, configured to, or operable to support a means for outputting second DCI that schedules a second set of one or more downlink shared channel transmissions. The second feedback manager 1235 is capable of, configured to, or operable to support a means for obtaining, during a second uplink channel transmission occasion based on a second slot offset, the first feedback information and second feedback information in a single payload, where the second feedback information is associated with the second set of one or more downlink shared channel transmissions.

In some examples, the first DCI indicates the first slot offset. In some examples, the second slot offset corresponds to a quantity of one or more slots relative to a next available slot from a reference slot corresponding to the first uplink channel transmission occasion.

In some examples, the transmission occasion manager 1240 is capable of, configured to, or operable to support a means for outputting signaling that indicates a quantity of one or more uplink channel transmission occasions to use to transmit feedback, where the quantity includes at least the first uplink channel transmission occasion and the second uplink channel transmission occasion.

In some examples, the first DCI indicates a quantity of one or more uplink channel transmission occasions to use to transmit feedback. In some examples, the quantity includes at least the first uplink channel transmission occasion and the second uplink channel transmission occasion.

In some examples, the first DCI indicates the first slot offset and the second slot offset.

In some examples, the first DCI indicates a first identifier associated with a set of slot offsets. In some examples, the set of slot offsets includes the first slot offset and the second slot offset.

In some examples, the first slot offset corresponds to a first quantity of one or more slots between a first downlink shared channel transmission of the first set of one or more downlink shared channel transmissions and the first uplink channel transmission occasion. In some examples, the second slot offset corresponds to a second quantity of one or more slots between the first downlink shared channel transmission and the second uplink channel transmission occasion.

In some examples, the first slot offset corresponds to a first quantity of one or more slots between a first downlink shared channel transmission of the first set of one or more downlink shared channel transmissions and the first uplink channel transmission occasion. In some examples, the second slot offset corresponds to a second quantity of one or more slots between the first uplink channel transmission occasion and the second uplink channel transmission occasion.

In some examples, the second uplink channel transmission occasion includes a feedback slot for a set of downlink shared channels that includes at least a first downlink shared channel transmission of the first set of one or more downlink shared channel transmissions and a second downlink shared channel of the second set of one or more downlink shared channel transmissions based on a difference between a slot index of the feedback slot and the second slot offset.

In some examples, the capability manager 1245 is capable of, configured to, or operable to support a means for obtaining capability information associated with a threshold quantity of uplink channel transmission occasions that a second network entity supports for feedback transmissions.

In some examples, the capability manager 1245 is capable of, configured to, or operable to support a means for obtaining capability information that indicates a threshold quantity of slots that a second network entity supports for buffering feedback information, where the threshold quantity of slots corresponds to a first quantity of slots after a downlink shared channel, or a second quantity of slots after an initial transmission of the feedback information.

In some examples, the capability manager 1245 is capable of, configured to, or operable to support a means for jointly decoding the first feedback information obtained via the first uplink channel transmission occasion and the first feedback information obtained via the second uplink channel transmission occasion.

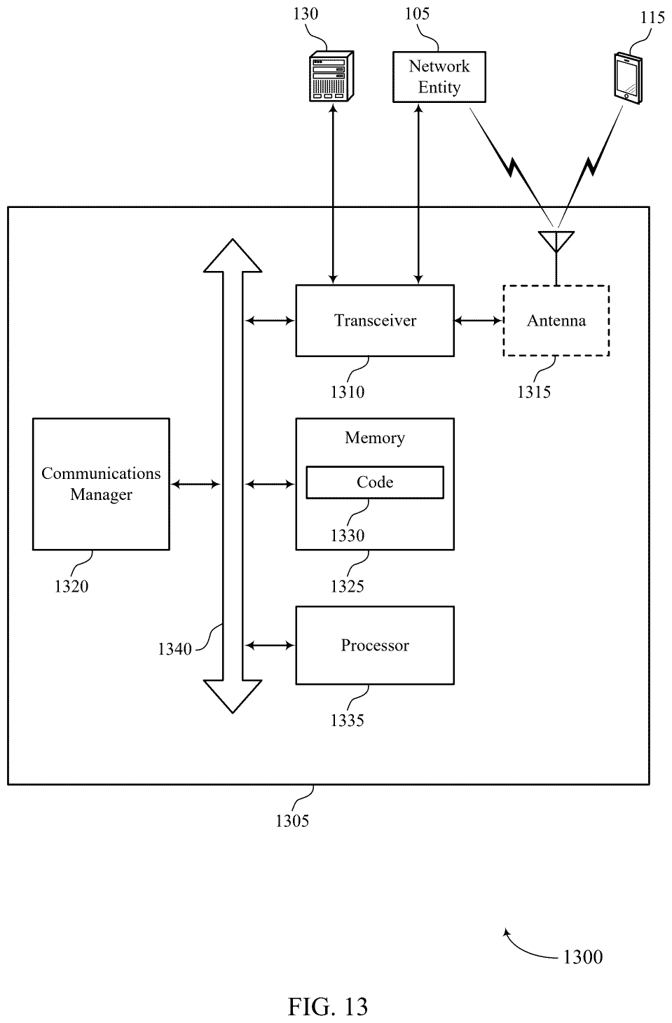

FIG. 13 shows a diagram of a system 1300 including a device 1305 that supports incremental redundancy and payload change for feedback in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting incremental redundancy and payload change for feedback). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for outputting first DCI that schedules a first set of one or more downlink shared channel transmissions. The communications manager 1320 is capable of, configured to, or operable to support a means for obtaining, during a first uplink channel transmission occasion based on a first slot offset, first feedback information associated with the first set of one or more downlink shared channel transmissions. The communications manager 1320 is capable of, configured to, or operable to support a means for outputting second DCI that schedules a second set of one or more downlink shared channel transmissions. The communications manager 1320 is capable of, configured to, or operable to support a means for obtaining, during a second uplink channel transmission occasion based on a second slot offset, the first feedback information and second feedback information in a single payload, where the second feedback information is associated with the second set of one or more downlink shared channel transmissions.

By including or configuring the communications manager 1320 in accordance with examples as described herein, the device 1305 may support techniques for incremental redundancy and payload change for feedback, which may result in improved communication reliability, reduced latency, improved user experience related to reduced processing, reduced power consumption, increased compatibility between devices, reduced channel restrictions, improved coordination between devices, and more efficient utilization of communication resources, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of incremental redundancy and payload change for feedback as described herein, or the at least one processor 1335 and the at least one memory 1325 may be otherwise configured to, individually or collectively, perform or support such operations.

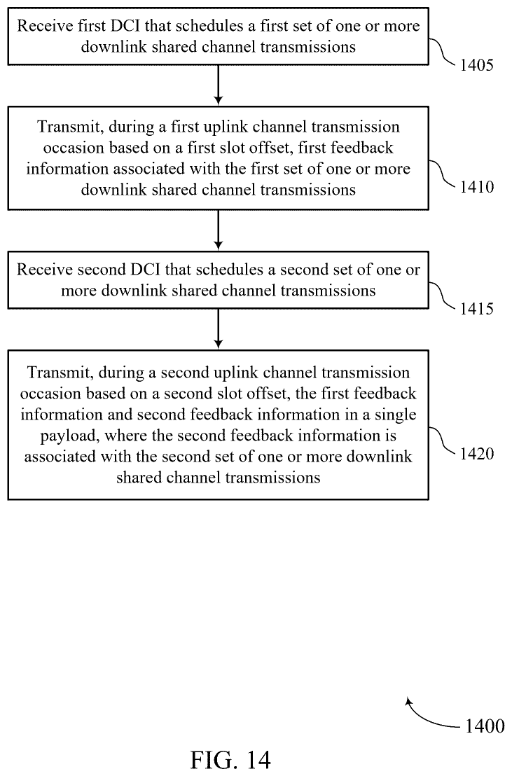

FIG. 14 shows a flowchart illustrating a method 1400 that supports incremental redundancy and payload change for feedback in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first DCI that schedules a first set of one or more downlink shared channel transmissions. The operations of 1405 may be performed in accordance with examples as disclosed herein. In some examples, aspects of the operations of 1405 may be performed by a DCI component 825 as described with reference to FIG. 8.

At 1410, the method may include transmitting, during a first uplink channel transmission occasion based on a first slot offset, first feedback information associated with the first set of one or more downlink shared channel transmissions. The operations of 1410 may be performed in accordance with examples as disclosed herein. In some examples, aspects of the operations of 1410 may be performed by a feedback component 830 as described with reference to FIG. 8.

At 1415, the method may include receiving second DCI that schedules a second set of one or more downlink shared channel transmissions. The operations of 1415 may be performed in accordance with examples as disclosed herein. In some examples, aspects of the operations of 1415 may be performed by a DCI component 825 as described with reference to FIG. 8.

At 1420, the method may include transmitting, during a second uplink channel transmission occasion based on a second slot offset, the first feedback information and second feedback information in a single payload, where the second feedback information is associated with the second set of one or more downlink shared channel transmissions. The operations of 1420 may be performed in accordance with examples as disclosed herein. In some examples, aspects of the operations of 1420 may be performed by a second feedback component 835 as described with reference to FIG. 8.

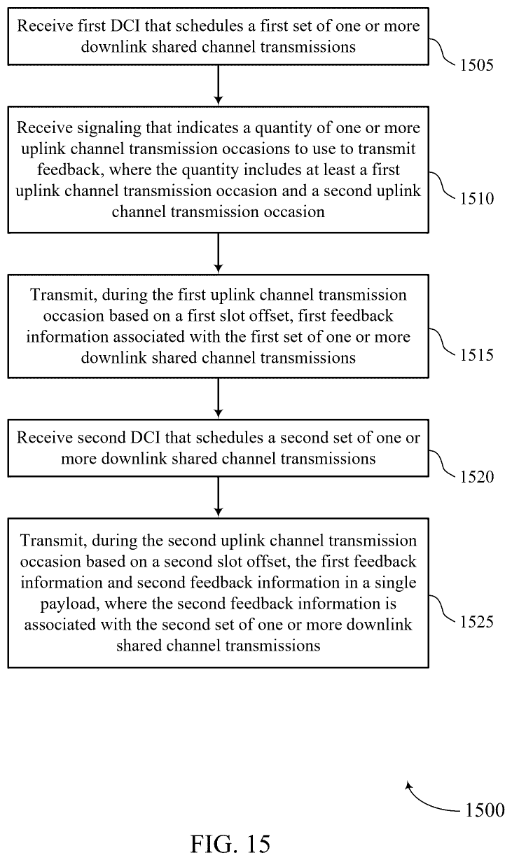

FIG. 15 shows a flowchart illustrating a method 1500 that supports incremental redundancy and payload change for feedback in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first DCI that schedules a first set of one or more downlink shared channel transmissions. The operations of 1505 may be performed in accordance with examples as disclosed herein. In some examples, aspects of the operations of 1505 may be performed by a DCI component 825 as described with reference to FIG. 8.

At 1510, the method may include receiving signaling that indicates a quantity of one or more uplink channel transmission occasions to use to transmit feedback, where the quantity includes at least a first uplink channel transmission occasion and a second uplink channel transmission occasion. The operations of 1510 may be performed in accordance with examples as disclosed herein. In some examples, aspects of the operations of 1510 may be performed by a transmission occasion component 840 as described with reference to FIG. 8.

At 1515, the method may include transmitting, during the first uplink channel transmission occasion based on a first slot offset, first feedback information associated with the first set of one or more downlink shared channel transmissions. The operations of 1515 may be performed in accordance with examples as disclosed herein. In some examples, aspects of the operations of 1515 may be performed by a feedback component 830 as described with reference to FIG. 8.

At 1520, the method may include receiving second DCI that schedules a second set of one or more downlink shared channel transmissions. The operations of 1520 may be performed in accordance with examples as disclosed herein. In some examples, aspects of the operations of 1520 may be performed by a DCI component 825 as described with reference to FIG. 8.

At 1525, the method may include transmitting, during the second uplink channel transmission occasion based on a second slot offset, the first feedback information and second feedback information in a single payload, where the second feedback information is associated with the second set of one or more downlink shared channel transmissions. The operations of 1525 may be performed in accordance with examples as disclosed herein. In some examples, aspects of the operations of 1525 may be performed by a second feedback component 835 as described with reference to FIG. 8.

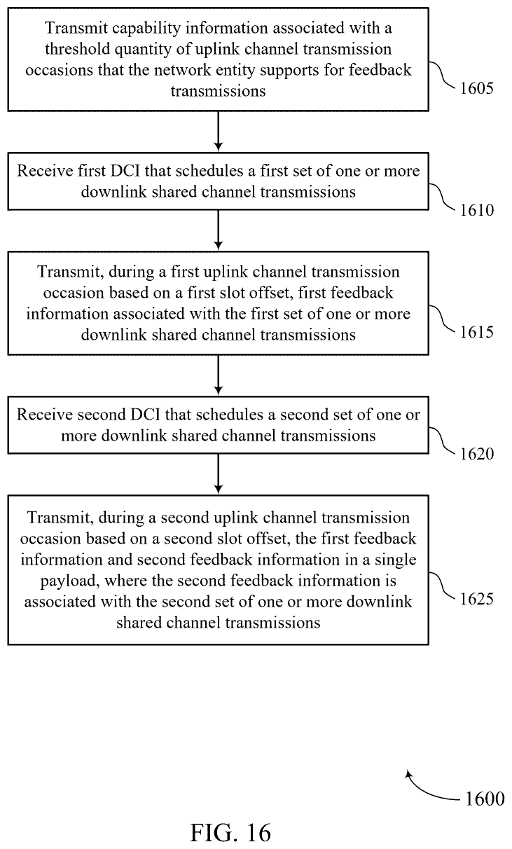

FIG. 16 shows a flowchart illustrating a method 1600 that supports incremental redundancy and payload change for feedback in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting capability information associated with a threshold quantity of uplink channel transmission occasions that the network entity supports for feedback transmissions. The operations of 1605 may be performed in accordance with examples as disclosed herein. In some examples, aspects of the operations of 1605 may be performed by a capability component 850 as described with reference to FIG. 8.

At 1610, the method may include receiving first DCI that schedules a first set of one or more downlink shared channel transmissions. The operations of 1610 may be performed in accordance with examples as disclosed herein. In some examples, aspects of the operations of 1610 may be performed by a DCI component 825 as described with reference to FIG. 8.

At 1615, the method may include transmitting, during a first uplink channel transmission occasion based on a first slot offset, first feedback information associated with the first set of one or more downlink shared channel transmissions. The operations of 1615 may be performed in accordance with examples as disclosed herein. In some examples, aspects of the operations of 1615 may be performed by a feedback component 830 as described with reference to FIG. 8.

At 1620, the method may include receiving second DCI that schedules a second set of one or more downlink shared channel transmissions. The operations of 1620 may be performed in accordance with examples as disclosed herein. In some examples, aspects of the operations of 1620 may be performed by a DCI component 825 as described with reference to FIG. 8.

At 1625, the method may include transmitting, during a second uplink channel transmission occasion based on a second slot offset, the first feedback information and second feedback information in a single payload, where the second feedback information is associated with the second set of one or more downlink shared channel transmissions. The operations of 1625 may be performed in accordance with examples as disclosed herein. In some examples, aspects of the operations of 1625 may be performed by a second feedback component 835 as described with reference to FIG. 8.

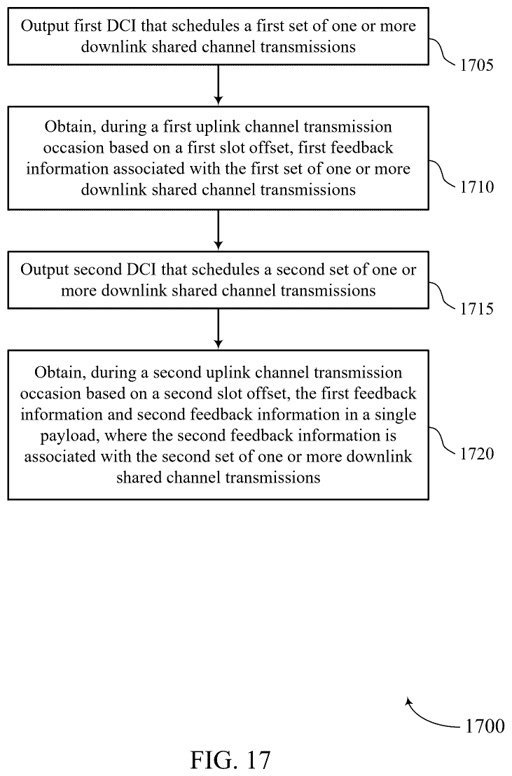

FIG. 17 shows a flowchart illustrating a method 1700 that supports incremental redundancy and payload change for feedback in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting first DCI that schedules a first set of one or more downlink shared channel transmissions. The operations of 1705 may be performed in accordance with examples as disclosed herein. In some examples, aspects of the operations of 1705 may be performed by a DCI manager 1225 as described with reference to FIG. 12.

At 1710, the method may include obtaining, during a first uplink channel transmission occasion based on a first slot offset, first feedback information associated with the first set of one or more downlink shared channel transmissions. The operations of 1710 may be performed in accordance with examples as disclosed herein. In some examples, aspects of the operations of 1710 may be performed by a feedback manager 1230 as described with reference to FIG. 12.

At 1715, the method may include outputting second DCI that schedules a second set of one or more downlink shared channel transmissions. The operations of 1715 may be performed in accordance with examples as disclosed herein. In some examples, aspects of the operations of 1715 may be performed by a DCI manager 1225 as described with reference to FIG. 12.

At 1720, the method may include obtaining, during a second uplink channel transmission occasion based on a second slot offset, the first feedback information and second feedback information in a single payload, where the second feedback information is associated with the second set of one or more downlink shared channel transmissions. The operations of 1720 may be performed in accordance with examples as disclosed herein. In some examples, aspects of the operations of 1720 may be performed by a second feedback manager 1235 as described with reference to FIG. 12.

The following provides an overview of aspects of the present disclosure:

Aspect 1: A method of wireless communication performed by a network entity, comprising: receiving first DCI that schedules a first set of one or more downlink shared channel transmissions; transmitting, during a first uplink channel transmission occasion based on a first slot offset, first feedback information associated with the first set of one or more downlink shared channel transmissions; receiving second DCI that schedules a second set of one or more downlink shared channel transmissions; and transmitting, during a second uplink channel transmission occasion based on a second slot offset, the first feedback information and second feedback information in a single payload, wherein the second feedback information is associated with the second set of one or more downlink shared channel transmissions.

Aspect 2: The method of aspect 1, wherein the first DCI indicates the first slot offset, and the second slot offset corresponds to a quantity of one or more slots relative to a next available slot from a reference slot corresponding to the first uplink channel transmission occasion.

Aspect 3: The method of aspect 2, wherein the next available slot does not overlap with a synchronization signal block or one or more downlink symbols.

Aspect 4: The method of any of aspects 1 through 3, further comprising: receiving signaling that indicates a quantity of one or more uplink channel transmission occasions to use to transmit feedback, wherein the quantity includes at least the first uplink channel transmission occasion and the second uplink channel transmission occasion.

Aspect 5: The method of aspect 4, wherein the signaling indicates a respective quantity of one or more uplink channel transmission occasions to use to transmit feedback for each downlink component carrier of a set of one or more downlink component carriers.

Aspect 6: The method of any of aspects 4 through 5, wherein the signaling indicates a respective quantity of one or more uplink channel transmission occasions to use to transmit feedback for each uplink component carrier of a set of one or more uplink component carriers.

Aspect 7: The method of any of aspects 4 through 6, wherein the signaling indicates a respective quantity of one or more uplink channel transmission occasions to use to transmit feedback for each uplink control channel format of a set of one or more uplink control channel formats.

Aspect 8: The method of any of aspects 4 through 7, wherein the signaling indicates a respective quantity of one or more uplink channel transmission occasions to use to transmit feedback for each uplink control channel resource of a set of one or more uplink control channel resources.

Aspect 9: The method of any of aspects 4 through 8, wherein the signaling comprises RRC signaling, MAC-CE signaling, DCI signaling, or a combination thereof.

Aspect 10: The method of any of aspects 1 through 9, wherein the first DCI indicates a quantity of one or more uplink channel transmission occasions to use to transmit feedback, and the quantity includes at least the first uplink channel transmission occasion and the second uplink channel transmission occasion.

Aspect 11: The method of any of aspects 1 through 10, wherein the first DCI indicates the first slot offset and the second slot offset.

Aspect 12: The method of any of aspects 1 through 11, wherein the first slot offset and the second slot offset are a same slot offset.

Aspect 13: The method of any of aspects 1 through 12, wherein the first DCI indicates a first identifier associated with a set of slot offsets, and the set of slot offsets comprises the first slot offset and the second slot offset.

Aspect 14: The method of any of aspects 1 through 13, wherein the first slot offset corresponds to a first quantity of one or more slots between a first downlink shared channel transmission of the first set of one or more downlink shared channel transmissions and the first uplink channel transmission occasion, and the second slot offset corresponds to a second quantity of one or more slots between the first downlink shared channel transmission and the second uplink channel transmission occasion.

Aspect 15: The method of any of aspects 1 through 14, wherein the first slot offset corresponds to a first quantity of one or more slots between a first downlink shared channel transmission of the first set of one or more downlink shared channel transmissions and the first uplink channel transmission occasion, and the second slot offset corresponds to a second quantity of one or more slots between the first uplink channel transmission occasion and the second uplink channel transmission occasion.

Aspect 16: The method of any of aspects 1 through 15, wherein transmitting the first feedback information and the second feedback information comprises: multiplexing the second feedback information and the first feedback information on a channel that overlaps with the second uplink channel transmission occasion.

Aspect 17: The method of any of aspects 1 through 16, wherein transmitting the first feedback information and the second feedback information comprises: multiplexing the second feedback information and the first feedback information with uplink control information, wherein the second uplink channel transmission occasion overlaps with an uplink control channel for the uplink control information, and wherein the uplink control information is transmitted with the second feedback information and the first feedback information.

Aspect 18: The method of any of aspects 1 through 17, wherein the second uplink channel transmission occasion comprises a feedback slot for a set of downlink shared channels that includes at least a first downlink shared channel transmission of the first set of one or more downlink shared channel transmissions and a second downlink shared channel transmission of the second set of one or more downlink shared channel transmissions based on a difference between a slot index of the feedback slot and the second slot offset.

Aspect 19: The method of any of aspects 1 through 18, further comprising: transmitting capability information associated with a threshold quantity of uplink channel transmission occasions that the network entity supports for feedback transmissions.

Aspect 20: The method of any of aspects 1 through 19, further comprising: transmitting capability information that indicates a threshold quantity of slots that the network entity supports for buffering feedback information, wherein the threshold quantity of slots corresponds to a quantity of slots after a downlink shared channel.

Aspect 21: The method of any of aspects 1 through 20, further comprising: transmitting capability information that indicates a threshold quantity of slots that the network entity supports for buffering feedback information, wherein the threshold quantity of slots corresponds to a quantity of slots after an initial transmission of the feedback information.

Aspect 22: A method of wireless communication performed by a network entity, comprising: outputting first DCI that schedules a first set of one or more downlink shared channel transmissions; obtaining, during a first uplink channel transmission occasion based on a first slot offset, first feedback information associated with the first set of one or more downlink shared channel transmissions; outputting second DCI that schedules a second set of one or more downlink shared channel transmissions; and obtaining, during a second uplink channel transmission occasion based on a second slot offset, the first feedback information and second feedback information in a single payload, wherein the second feedback information is associated with the second set of one or more downlink shared channel transmissions.

Aspect 23: The method of aspect 22, wherein the first DCI indicates the first slot offset, and the second slot offset corresponds to a quantity of one or more slots relative to a next available slot from a reference slot corresponding to the first uplink channel transmission occasion.

Aspect 24: The method of any of aspects 22 through 23, further comprising: outputting signaling that indicates a quantity of one or more uplink channel transmission occasions to use to transmit feedback, wherein the quantity includes at least the first uplink channel transmission occasion and the second uplink channel transmission occasion.

Aspect 25: The method of any of aspects 22 through 24, wherein the first DCI indicates a quantity of one or more uplink channel transmission occasions to use to transmit feedback, the quantity includes at least the first uplink channel transmission occasion and the second uplink channel transmission occasion.

Aspect 26: The method of any of aspects 22 through 25, wherein the first DCI indicates the first slot offset and the second slot offset.

Aspect 27: The method of any of aspects 22 through 26, wherein the first DCI indicates a first identifier associated with a set of slot offsets, and the set of slot offsets comprises the first slot offset and the second slot offset.

Aspect 28: The method of any of aspects 22 through 27, wherein the first slot offset corresponds to a first quantity of one or more slots between a first downlink shared channel transmission of the first set of one or more downlink shared channel transmissions and the first uplink channel transmission occasion, and the second slot offset corresponds to a second quantity of one or more slots between the first downlink shared channel transmission and the second uplink channel transmission occasion.

Aspect 29: The method of any of aspects 22 through 28, wherein the first slot offset corresponds to a first quantity of one or more slots between a first downlink shared channel transmission of the first set of one or more downlink shared channel transmissions and the first uplink channel transmission occasion, and the second slot offset corresponds to a second quantity of one or more slots between the first uplink channel transmission occasion and the second uplink channel transmission occasion.

Aspect 30: The method of any of aspects 22 through 29, wherein the second uplink channel transmission occasion comprises a feedback slot for a set of downlink shared channels that includes at least a first downlink shared channel transmission of the first set of one or more downlink shared channel transmissions and a second downlink shared channel of the second set of one or more downlink shared channel transmissions based on a difference between a slot index of the feedback slot and the second slot offset.

Aspect 31: The method of any of aspects 22 through 30, further comprising: obtaining capability information associated with a threshold quantity of uplink channel transmission occasions that a second network entity supports for feedback transmissions.

Aspect 32: The method of any of aspects 22 through 31, further comprising: obtaining capability information that indicates a threshold quantity of slots that a second network entity supports for buffering feedback information, wherein the threshold quantity of slots corresponds to a first quantity of slots after a downlink shared channel, or a second quantity of slots after an initial transmission of the feedback information.

Aspect 33: The method of any of aspects 22 through 32, further comprising: jointly decoding the first feedback information obtained via the first uplink channel transmission occasion and the first feedback information obtained via the second uplink channel transmission occasion.

Aspect 34: A network entity for wireless communication, comprising one or more memories storing processor-executable code, and one or more processors coupled with the one or more memories and individually or collectively operable to execute the code to cause the network entity to perform a method of any of aspects 1 through 21.

Aspect 35: A network entity for wireless communication, comprising at least one means for performing a method of any of aspects 1 through 21.

Aspect 36: A non-transitory computer-readable medium storing code for wireless communication, the code comprising instructions executable by one or more processors to perform a method of any of aspects 1 through 21.

Aspect 37: A network entity for wireless communication, comprising one or more memories storing processor-executable code, and one or more processors coupled with the one or more memories and individually or collectively operable to execute the code to cause the network entity to perform a method of any of aspects 22 through 33.

Aspect 38: A network entity for wireless communication, comprising at least one means for performing a method of any of aspects 22 through 33.

Aspect 39: A non-transitory computer-readable medium storing code for wireless communication, the code comprising instructions executable by one or more processors to perform a method of any of aspects 22 through 33.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
a processing system configured to:
receive first downlink control information (DCI) that schedules a first set of one or more downlink shared channel transmissions;
transmit, during a first uplink channel transmission occasion based on a first slot offset, first feedback information associated with the first set of one or more downlink shared channel transmissions;
receive second DCI that schedules a second set of one or more downlink shared channel transmissions; and
transmit, during a second uplink channel transmission occasion based on a second slot offset, the first feedback information and second feedback information in a single payload, wherein the second feedback information is associated with the second set of one or more downlink shared channel transmissions.

2. The network entity of claim 1, wherein:
the first DCI indicates the first slot offset, and
the second slot offset corresponds to a quantity of one or more slots relative to a next available slot from a reference slot corresponding to the first uplink channel transmission occasion.

3. The network entity of claim 2, wherein the next available slot does not overlap with a synchronization signal block or one or more downlink symbols.

4. The network entity of claim 1, wherein the processing system is configured to:
receive signaling that indicates a quantity of one or more uplink channel transmission occasions to use to transmit feedback, wherein the quantity includes at least the first uplink channel transmission occasion and the second uplink channel transmission occasion.

5. The network entity of claim 4, wherein the signaling indicates a respective quantity of one or more uplink channel transmission occasions to use to transmit feedback for each downlink component carrier of a set of one or more downlink component carriers.

6. The network entity of claim 4, wherein the signaling indicates a respective quantity of one or more uplink channel transmission occasions to use to transmit feedback for each uplink component carrier of a set of one or more uplink component carriers.

7. The network entity of claim 4, wherein the signaling indicates a respective quantity of one or more uplink channel transmission occasions to use to transmit feedback for each uplink control channel format of a set of one or more uplink control channel formats.

8. The network entity of claim 4, wherein the signaling indicates a respective quantity of one or more uplink channel transmission occasions to use to transmit feedback for each uplink control channel resource of a set of one or more uplink control channel resources.

9. The network entity of claim 4, wherein the signaling comprises radio resource control signaling, medium access control-control element signaling, DCI signaling, or a combination thereof.

10. The network entity of claim 1, wherein:
the first DCI indicates a quantity of one or more uplink channel transmission occasions to use to transmit feedback, and
the quantity includes at least the first uplink channel transmission occasion and the second uplink channel transmission occasion.

11. The network entity of claim 1, wherein the first DCI indicates the first slot offset and the second slot offset.

12. The network entity of claim 1, wherein the first slot offset and the second slot offset are a same slot offset.

13. The network entity of claim 1, wherein:
the first DCI indicates a first identifier associated with a set of slot offsets, and
the set of slot offsets comprises the first slot offset and the second slot offset.

14. The network entity of claim 1, wherein:
the first slot offset corresponds to a first quantity of one or more slots between a first downlink shared channel transmission of the first set of one or more downlink shared channel transmissions and the first uplink channel transmission occasion, and
the second slot offset corresponds to a second quantity of one or more slots between the first downlink shared channel transmission and the second uplink channel transmission occasion.

15. The network entity of claim 1, wherein:
the first slot offset corresponds to a first quantity of one or more slots between a first downlink shared channel transmission of the first set of one or more downlink shared channel transmissions and the first uplink channel transmission occasion, and
the second slot offset corresponds to a second quantity of one or more slots between the first uplink channel transmission occasion and the second uplink channel transmission occasion.

16. The network entity of claim 1, wherein, to transmit the first feedback information and the second feedback information, the processing system is configured to:
multiplex the second feedback information and the first feedback information on a channel that overlaps with the second uplink channel transmission occasion.

17. The network entity of claim 1, wherein, to transmit the first feedback information and the second feedback information, the processing system is configured to:
multiplex the second feedback information and the first feedback information with uplink control information, wherein the second uplink channel transmission occasion overlaps with an uplink control channel for the uplink control information, and wherein the uplink control information is transmitted with the second feedback information and the first feedback information.

18. The network entity of claim 1, wherein the second uplink channel transmission occasion comprises a feedback slot for a set of downlink shared channels that includes at least a first downlink shared channel transmission of the first set of one or more downlink shared channel transmissions and a second downlink shared channel transmission of the second set of one or more downlink shared channel transmissions based on a difference between a slot index of the feedback slot and the second slot offset.

19. The network entity of claim 1, wherein the processing system is configured to:
transmit capability information associated with a threshold quantity of uplink channel transmission occasions that the network entity supports for feedback transmissions.

20. The network entity of claim 1, wherein the processing system is configured to:
transmit capability information that indicates a threshold quantity of slots that the network entity supports for buffering feedback information, wherein the threshold quantity of slots corresponds to a quantity of slots after a downlink shared channel.

21. The network entity of claim 1, wherein the processing system is configured to:
transmit capability information that indicates a threshold quantity of slots that the network entity supports for buffering feedback information, wherein the threshold quantity of slots corresponds to a quantity of slots after an initial transmission of the feedback information.

22. A network entity, comprising:
a processing system configured to:
output first downlink control information (DCI) that schedules a first set of one or more downlink shared channel transmissions;
obtain, during a first uplink channel transmission occasion based on a first slot offset, first feedback information associated with the first set of one or more downlink shared channel transmissions;
output second DCI that schedules a second set of one or more downlink shared channel transmissions; and
obtain, during a second uplink channel transmission occasion based on a second slot offset, the first feedback information and second feedback information in a single payload, wherein the second feedback information is associated with the second set of one or more downlink shared channel transmissions.

23. The network entity of claim 22, wherein the processing system is configured to:
output signaling that indicates a quantity of one or more uplink channel transmission occasions to use to transmit feedback, wherein the quantity includes at least the first uplink channel transmission occasion and the second uplink channel transmission occasion.

24. The network entity of claim 22, wherein the processing system is configured to:
obtain capability information associated with a threshold quantity of uplink channel transmission occasions that a second network entity supports for feedback transmissions.

25. The network entity of claim 22, the processing system is configured to:
obtain capability information that indicates a threshold quantity of slots that a second network entity supports for buffering feedback information, wherein the threshold quantity of slots corresponds to a first quantity of slots after a downlink shared channel, or a second quantity of slots after an initial transmission of the feedback information.

26. The network entity of claim 22, the processing system is configured to:
jointly decode the first feedback information obtained via the first uplink channel transmission occasion and the first feedback information obtained via the second uplink channel transmission occasion.

27. A method of wireless communication performed by a network entity, comprising:
receiving first downlink control information (DCI) that schedules a first set of one or more downlink shared channel transmissions;
transmitting, during a first uplink channel transmission occasion based on a first slot offset, first feedback information associated with the first set of one or more downlink shared channel transmissions;
receiving second DCI that schedules a second set of one or more downlink shared channel transmissions; and
transmitting, during a second uplink channel transmission occasion based on a second slot offset, the first feedback information and second feedback information in a single payload, wherein the second feedback information is associated with the second set of one or more downlink shared channel transmissions.

28. The method of claim 27, further comprising:
receiving signaling that indicates a quantity of one or more uplink channel transmission occasions to use to transmit feedback, wherein the quantity includes at least the first uplink channel transmission occasion and the second uplink channel transmission occasion.

29. A method of wireless communication performed by a network entity, comprising:
outputting first downlink control information (DCI) that schedules a first set of one or more downlink shared channel transmissions;
obtaining, during a first uplink channel transmission occasion based on a first slot offset, first feedback information associated with the first set of one or more downlink shared channel transmissions;
outputting second DCI that schedules a second set of one or more downlink shared channel transmissions; and
obtaining, during a second uplink channel transmission occasion based on a second slot offset, the first feedback information and second feedback information in a single payload, wherein the second feedback information is associated with the second set of one or more downlink shared channel transmissions.

30. The method of claim 29, further comprising:
outputting signaling that indicates a quantity of one or more uplink channel transmission occasions to use to transmit feedback, wherein the quantity includes at least the first uplink channel transmission occasion and the second uplink channel transmission occasion.
